(19) United States
(12) Patent Application Publication
(10) Pub. No.: US 2020/0373989 A1
(43) Pub. Date: Nov. 26, 2020

(54) METHOD AND APPARATUS FOR BEAM RECOVERY

(71) Applicant: INTEL IP CORPORATION, Santa Clara, CA (US)

(72) Inventors: Leiqin Yan, Beijing (CN); Yushu Zhang, Beijing (CN); Gang Xiong, Beaverton, OR (US); Guotong Wang, Beijing (CN); Alexei Davydov, Nizhny Novgorod NIZ (RU)

(21) Appl. No.: 16/637,165

(22) PCT Filed: Aug. 9, 2018
(86) PCT No.: PCT/CN2018/099641

§ 371 Date: Feb. 6, 2020

(30) Foreign Application Priority Data
Aug. 11, 2017 (CN) PCT/CN2017/097141
Aug. 21, 2017 (CN) PCT/CN2017/098346

(51) Int. Cl. H04B 7/06; H04W 74/08; H04W 52/50; H04W 52/36; H04W 80/08; H04W 56/00; H04L 5/00; H04W 76/27; H04L 5/10; H04W 72/00; H04W 80/02

(52) U.S. Cl. CPC H04B 7/0695; H04B 7/0617; H04W 74/0833; H04W 52/50; H04W 52/367; H04W 80/08; H04W 80/02; H04B 7/0626; H04L 5/0051; H04W 76/27; H04L 5/10; H04W 72/005; H04W 56/001

(57) ABSTRACT

Provided herein are method and apparatus for beam recovery. It provides an apparatus for a UE (101) including a radio frequency (RF) interface; and processing circuitry configured to: determine beam quality for one or more BPLs between the UE (101) and an access node (111,112); and in response to the beam quality for all of the BPLs being below a first predetermined threshold, encode Physical Random Access Channel (PRACH) data to include a beam recovery request that identifies a candidate beam of the access node (111,112); determine a transmit power for the beam recovery request; and send the PRACH data to the RF interface for transmission to the access node (111,112) with the transmit power. At least some embodiments allow for determining a transmission power to transmit a PRACH, to ensure reception of the PRACH, and allow for determining whether to use a PRACH or a PUCHH.

### CROSS REFERENCES TO RELATED APPLICATIONS

This application claims priority to International Application No. PCT/CN2017/097141 filed on Aug. 11, 2017, entitled “BEAM RECOVERY WITHOUT BEAM CORRESPONDENCE”, and International Application No. PCT/CN2017/098436 filed on Aug. 21, 2017, entitled “RECONFIGURATION OF CHANNEL STATE INFORMATION REFERENCE SIGNAL”, which are incorporated by reference herein in their entirety for all purposes.

### TECHNICAL FIELD

Embodiments of the present disclosure generally relate to a method and apparatus for wireless communications, and in particular to a method and apparatus for beam recovery.

### BACKGROUND ART

When beam quality for all configured beam pair links (BPLs) of a control channel between a user equipment (UE) and an access node (such as a next Generation NodeB (gNB)) is not good enough (e.g., below a predetermined threshold), the UE can transmit a beam recovery request to the access node to indicate a candidate beam of the access node so that the access node can reconfigure one or more BPLs for the UE. The beam recovery request can be carried by a Physical Random Access Channel (PRACH) or a Physical Uplink Control Channel (PUCCH).

For a case without beam correspondence, the UE has to transmit the beam recovery request by transmitting a PRACH to implicitly indicate a candidate beam of the access node for beam recovery, however, the PRACH may not be successfully received due to a bad receive beam of the access node without beam correspondence. Therefore, it is important to ensure an access node to reliably receive a PRACH carrying a beam recovery request for beam recovery.

### SUMMARY

An embodiment of the disclosure provides an apparatus for a user equipment (UE) including a radio frequency (RF) interface; and processing circuitry configured to: determine beam quality for one or more beam pair links (BPLs) between the UE and an access node; and in response to the beam quality for all of the BPLs being below a first predetermined threshold, encode Physical Random Access Channel (PRACH) data to include a beam recovery request that identifies a candidate beam of the access node; determine a transmit power for the beam recovery request; and send the PRACH data to the RF interface for transmission to the access node with the transmit power.

### BRIEF DESCRIPTION OF THE DRAWINGS

Embodiments of the disclosure will be illustrated, by way of example and not limitation, in the figures of the accompanying drawings in which like reference numerals refer to similar elements.

FIG. 1 shows an architecture of a system of a network in accordance with some embodiments of the disclosure.

FIG. 2 shows an example for one or more BPLs between a UE and an access node in accordance with some embodiments of the disclosure.

FIG. 3 is a flow chart showing operations for beam recovery in accordance with some embodiments of the disclosure.

FIG. 4 is a flow chart showing a method performed by a UE for beam recovery in accordance with some embodiments of the disclosure.

FIG. 5 is a flow chart showing operations for beam recovery in accordance with some embodiments of the disclosure.

FIG. 6 is a flow chart showing a method performed by a UE for beam recovery in accordance with some embodiments of the disclosure.

FIG. 7 is a flow chart showing operations for reconfiguration of a CSI-RS in accordance with some embodiments of the disclosure.

FIG. 8 is a flow chart showing a method performed by an access node for reconfiguration of a CSI-RS in accordance with some embodiments of the disclosure.

FIG. 9 is a flow chart showing a method performed by a UE for reconfiguration of a CSI-RS in accordance with some embodiments of the disclosure.

FIG. 10 illustrates example components of a device in accordance with some embodiments of the disclosure.

FIG. 11 illustrates example interfaces of baseband circuitry in accordance with some embodiments.

FIG. 12 is an illustration of a control plane protocol stack in accordance with some embodiments.

FIG. 13 is a block diagram illustrating components, according to some example embodiments, able to read instructions from a machine-readable or computer-readable medium and perform any one or more of the methodologies discussed herein.

### DETAILED DESCRIPTION OF EMBODIMENTS

Various aspects of the illustrative embodiments will be described using terms commonly employed by those skilled in the art to convey the substance of their work to others skilled in the art. However, it will be apparent to those skilled in the art that many alternate embodiments may be practiced using portions of the described aspects. For purposes of explanation, specific numbers, materials, and configurations are set forth in order to provide a thorough understanding of the illustrative embodiments. However, it will be apparent to those skilled in the art that alternate embodiments may be practiced without the specific details. In other instances, well known features may have been omitted or simplified in order to avoid obscuring the illustrative embodiments.

Further, various operations will be described as multiple discrete operations, in turn, in a manner that is most helpful in understanding the illustrative embodiments; however, the order of description should not be construed as to imply that these operations are necessarily order dependent. In particular, these operations need not be performed in the order of presentation.

The phrase “in an embodiment” is used repeatedly herein. The phrase generally does not refer to the same embodiment; however, it may. The terms “comprising,” “having,” and “including” are synonymous, unless the context dictates otherwise. The phrases “A or B” and “A/B” mean “(A), (B), or (A and B).”

In a Multiple-Input and Multiple-Output (MIMO) system operating in high band, hybrid beamforming can be applied. An access node (e.g., a gNB) and a UE may maintain a plurality of beams. There may be multiple BPLs between the access node and the UE, which can provide good beamforming gain. A good BPL can help to increase link budget. As discussed previously, when beam quality for all configured BPLs of a control channel between the UE and the access node is not good enough (e.g., below a predetermined threshold), the UE can transmit a beam recovery request to the access node to indicate a candidate beam of the access node so that the access node can reconfigure one or more BPLs for the UE. The beam recovery request can be carried by a PRACH or a PUCCH.

One way to transmit a beam recovery request is to transmit a PRACH. The procedure of using a PRACH to transmit the beam recovery request is similar to the procedure of using a RACH. A set of resources for a PRACH may be preconfigured, and each of the resources for the PRACH may be associated with a beam of the access node, namely, a time or frequency resource for the PRACH may be used to carry information regarding a beam index of a beam of the access node. The UE may determine one of the resources for the PRACH based on a new uplink transmit beam selected by the UE. Therefore, selection of a resource for the PRACH may implicitly indicate which beam of the access node is selected as a candidate beam for beam recovery. For a case without beam correspondence, the UE has to transmit the beam recovery request by transmitting a PRACH in corresponding time or frequency resources to implicitly indicate a candidate beam of the access node for beam recovery, however, the PRACH may not be successfully received by a current or best receive beam of the access node. Therefore, it is important to select a proper transmission power to transmit a PRACH carrying a beam recovery request when there is no beam correspondence, so as to ensure an access node to reliably receive the PRACH for beam recovery.

Another way to transmit a beam recovery request is to transmit a PUCCH. This is also one way to ensure reliable reception of a beam recovery request. By using this way, the beam recovery request may be transmitted by transmitting a PUCCH carrying a message to explicitly indicate a candidate beam of the access node, however, compared with transmitting a PRACH, it would need to carry more payload and hence require more system resources. Therefore, it is important to determine whether to use a PRACH or a PUCCH to transmit a beam recovery request is a better choice in different cases.

As an example for illustrating the two ways (using a PRACH or PUCCH) to transmit a beam recovery request, it is assumed that a current uplink transmission is based on a first beam of the access node, and a new or candidate beam for beam recovery is a second beam of the access node. As one way to transmit the beam recovery request, the UE may transmit the beam recovery request by transmitting a PRACH to a resource for the second beam to implicitly inform the access node that the new or candidate beam is the second beam. However, the PRACH may not be successfully received. As another way to transmit the beam recovery request, although the new or candidate beam of the access node is the second beam, the UE may still transmit the beam recovery request by transmitting a PUCCH carrying a message to a resource for the first beam, wherein the message explicitly indicates the new or candidate beam of the access node is the second beam. Therefore, compared with transmitting a PRACH, it would need to carry more payloads and hence require more system resources.

The present disclosure provides approaches for beam recovery. In accordance with some embodiments of the disclosure, beam quality for one or more BPLs between a UE and an access node may be determined. In response to the beam quality for all of the BPLs being below a first predetermined threshold, a beam recovery request may be encoded for transmission via a PRACH to the access node, and a transmit power for the beam recovery request may be determined, wherein the beam recovery request identifies a candidate beam of the access node.

In a MIMO system operating in high band, hybrid beamforming can be applied. An access node (e.g., a gNB) and a UE may maintain a plurality of beams. There may be multiple BPLs between the access node and the UE, which can provide a good beamforming gain. A good BPL can help to increase link budget. Some beam sweeping based reference signals, such as an SS block and a CSI-RS, can be used to help the UE to find out a good BPL. However, the overhead of one SS block could take 4 symbols, so one possible way is to apply wide beams in an SS block and narrow beams in a CSI-RS.

The UE may report, to the access node, beam quality of an SS block which is transmitted from the access node with a beam sweeping operation. The access node may identify one or more coarse transmission directions, namely one or more wide beams applied in the SS block, based on the reported beam quality regarding the SS block. Then the access node may transmit a CSI-RS with a beam sweeping operation via narrow beams around the coarse transmission directions. The UE may then report beam quality of the CSI-RS to the access node. Finally the access node may identify one or more beams for transmission (such as, for a data and/or control channel) based on the reported beam quality regarding the CSI-RS.

As such, identifying one or more correct coarse transmission directions (namely, one or more wide beams applied in an SS block) is the first step to correctly identify one or more beams (namely, one or more narrow beams applied in a CSI-RS around the coarse transmission directions) for transmission.

If the coarse transmission directions have changed (for example, if the UE has moved), since the access node will not know the change unless the UE inform it, the access node may still configure the CSI-RS around the outdated coarse transmission directions, which may cause that the identified beams for transmission are not suitable. Therefore, it is important and necessary to provide information regarding the changed coarse transmission directions to reconfigure the CSI-RS around the changed coarse transmission directions, so as to correctly identify one or more beams for transmission based on the reconfigured CSI-RS.

The present disclosure provides approaches to perform reconfiguration of a CSI-RS. In accordance with some embodiments of the disclosure, an access node may encode an SS block for transmission to a UE. Then the UE may decode the SS block received from the access node, and encode a message based on the decoded SS block for transmission to the access node, wherein the message identifies one or more beam indexes of one or more beams for the SS block. Then the access node may decode the message received from the UE, and update a configuration of a CSI-RS (namely, reconfigure the CSI-RS), based on the decoded message.

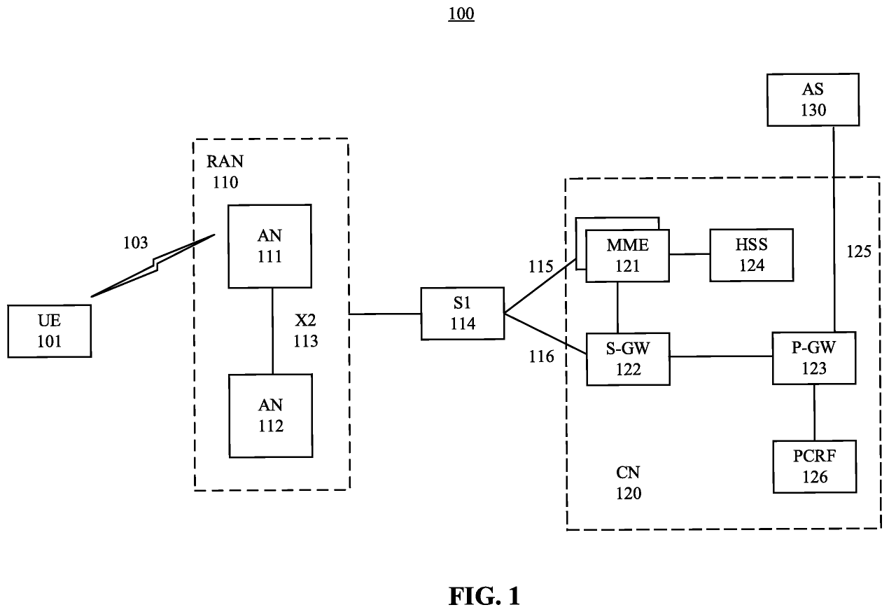

FIG. 1 illustrates an architecture of a system 100 of a network in accordance with some embodiments. The system 100 is shown to include a user equipment (UE) 101. The UE 101 is illustrated as a smartphone (e.g., handheld touchscreen mobile computing devices connectable to one or more cellular networks), but may also include any mobile or non-mobile computing device, such as a personal data assistant (PDA), a tablet, a pager, a laptop computer, a desktop computer, a wireless handset, or any computing device including a wireless communications interface.

The UE 101 may be configured to connect, e.g., communicatively couple, with a radio access network (RAN) 110, which may be, for example, an Evolved Universal Mobile Telecommunications System (UMTS) Terrestrial Radio Access Network (E-UTRAN), a NextGen RAN (NG RAN), or some other type of RAN. The UE 101 may utilize a connection 103 which comprises a physical communications interface or layer (discussed in further detail below); in this example, the connection 103 is illustrated as an air interface to enable communicative coupling and may be consistent with cellular communications protocols, such as a Global System for Mobile Communications (GSM) protocol, a Code-Division Multiple Access (CDMA) network protocol, a Push-to-Talk (PTT) protocol, a PTT over Cellular (POC) protocol, a Universal Mobile Telecommunications System (UMTS) protocol, a 3GPP Long Term Evolution (LTE) protocol, a fifth generation (5G) protocol, a New Radio (NR) protocol, and the like.

The RAN 110 may include one or more access nodes (ANs) that enable the connection 103. These access nodes may be referred to as base stations (BSs), NodeBs, evolved NodeBs (eNBs), next Generation NodeBs (gNB), RAN nodes, and so forth, and may include ground stations (e.g., terrestrial access points) or satellite stations providing coverage within a geographic area (e.g., a cell). As shown in FIG. 1, for example, the RAN 110 may include AN 111 and AN 112. The AN 111 and AN 112 may communicate with one another via an X2 interface 113. The AN 111 and AN 112 may be macro ANs which may provide lager coverage. Alternatively, they may be femtocell ANs or picocell ANs, which may provide smaller coverage areas, smaller user capacity, or higher bandwidth compared to macro ANs. For example, one or both of the AN 111 and AN 112 may be a low power (LP) AN. In an embodiment, the AN 111 and AN 112 may be the same type of AN. In another embodiment, they are different types of ANs.

Any of the ANs 111 and 112 may terminate the air interface protocol and may be the first point of contact for the UE 101. In some embodiments, any of the ANs 111 and 112 may fulfill various logical functions for the RAN 110 including, but not limited to, radio network controller (RNC) functions such as radio bearer management, uplink and downlink dynamic radio resource management and data packet scheduling, and mobility management.

In accordance with some embodiments, the UE 101 may be configured to communicate using Orthogonal Frequency-Division Multiplexing (OFDM) communication signals with any of the ANs 111 and 112 or with other UEs (not shown) over a multicarrier communication channel in accordance various communication techniques, such as, but not limited to, an Orthogonal Frequency-Division Multiple Access (OFDMA) communication technique (e.g., for downlink communications) or a Single Carrier Frequency Division Multiple Access (SC-FDMA) communication technique (e.g., for uplink and Proximity-Based Service (ProSe) or sidelink communications), although the scope of the embodiments is not limited in this respect. The OFDM signals may include a plurality of orthogonal subcarriers.

In some embodiments, a downlink resource grid may be used for downlink transmissions from any of the ANs 111 and 112 to the UE 101, while uplink transmissions may utilize similar techniques. The grid may be a time-frequency grid, called a resource grid or time-frequency resource grid, which is the physical resource in the downlink in each slot. Such a time-frequency plane representation is a common practice for OFDM systems, which makes it intuitive for radio resource allocation. Each column and each row of the resource grid corresponds to one OFDM symbol and one OFDM subcarrier, respectively. The duration of the resource grid in the time domain corresponds to one slot in a radio frame. The smallest time-frequency unit in a resource grid is denoted as a resource element. Each resource grid comprises a number of resource blocks, which describe the mapping of certain physical channels to resource elements. Each resource block comprises a collection of resource elements; in the frequency domain, this may represent the smallest quantity of resources that currently can be allocated. There are several different physical downlink channels that are conveyed using such resource blocks.

The physical downlink shared channel (PDSCH) may carry user data and higher-layer signaling to the UE 101. The physical downlink control channel (PDCCH) may carry information about the transport format and resource allocations related to the PDSCH channel, among other things. It may also inform the UE 101 about the transport format, resource allocation, and H-ARQ (Hybrid Automatic Repeat Request) information related to the uplink shared channel. Typically, downlink scheduling (assigning control and shared channel resource blocks to the UE 101 within a cell) may be performed at any of the ANs 111 and 112 based on channel quality information fed back from the UE 101. The downlink resource assignment information may be sent on the PDCCH used for (e.g., assigned to) the UE 101.

The PDCCH may use control channel elements (CCEs) to convey the control information. Before being mapped to resource elements, the PDCCH complex-valued symbols may first be organized into quadruplets, which may then be permuted using a sub-block interleaver for rate matching. Each PDCCH may be transmitted using one or more of these CCEs, where each CCE may correspond to nine sets of four physical resource elements known as resource element groups (REGs). Four Quadrature Phase Shift Keying (QPSK) symbols may be mapped to each REG. The PDCCH may be transmitted using one or more CCEs, depending on the size of the downlink control information (DCI) and the channel condition. There may be four or more different PDCCH formats defined in LTE with different numbers of CCEs (e.g., aggregation level, L=1, 2, 4, or 8).

Some embodiments may use concepts for resource allocation for control channel information that are an extension of the above-described concepts. For example, some embodiments may utilize an enhanced physical downlink control channel (EPDCCH) that uses PDSCH resources for control information transmission. The EPDCCH may be transmitted using one or more enhanced control channel elements (ECCEs). Similar to above, each ECCE may correspond to nine sets of four physical resource elements known as an enhanced resource element groups (EREGs). An ECCE may have other numbers of EREGs in some situations.

The RAN 110 is shown to be communicatively coupled to a core network (CN) 120 via an S1 interface 114. In some embodiments, the CN 120 may be an evolved packet core (EPC) network, a NextGen Packet Core (NPC) network, or some other type of CN. In an embodiment, the S1 interface 114 is split into two parts: the S1-mobility management entity (MNOE) interface 115, which is a signaling interface between the ANs 111 and 112 and NEs 121; and the S1-U interface 116, which carries traffic data between the ANs 111 and 112 and the serving gateway (S-GW) 122.

In an embodiment, the CN 120 may comprise the MMDEs 121, the S-GW 122, a Packet Data Network (PDN) Gateway (P-GW) 123, and a home subscriber server (HSS) 124. The MNEs 121 may be similar in function to the control plane of legacy Serving General Packet Radio Service (GPRS) Support Nodes (SGSN). The MMDEs 121 may manage mobility aspects in access such as gateway selection and tracking area list management. The HSS 124 may comprise a database for network users, including subscription-related information to support the network entities' handling of communication sessions. The CN 120 may comprise one or several HSSs 124, depending on the number of mobile subscribers, on the capacity of the equipment, on the organization of the network, etc. For example, the HSS 124 can provide support for routing/roaming, authentication, authorization, naming/addressing resolution, location dependencies, etc.

The S-GW 122 may terminate the S1 interface 113 towards the RAN 110, and routes data packets between the RAN 110 and the CN 120. In addition, the S-GW 122 may be a local mobility anchor point for inter-AN handovers and also may provide an anchor for inter-3GPP mobility. Other responsibilities may include lawful intercept, charging, and some policy enforcement.

The P-GW 123 may terminate a SGi interface toward a PDN. The P-GW 123 may route data packets between the CN 120 and external networks such as a network including an application server (AS) 130 (alternatively referred to as application function (AF)) via an Internet Protocol (IP) interface 125. Generally, the application server 130 may be an element offering applications that use IP bearer resources with the core network (e.g., UMTS Packet Services (PS) domain, LTE PS data services, etc.). In an embodiment, the P-GW 123 is communicatively coupled to an application server 130 via an IP communications interface 125. The application server 130 may also be configured to support one or more communication services (e.g., Voice-over-Internet Protocol (VoIP) sessions, PTT sessions, group communication sessions, social networking services, etc.) for the UE 101 via the CN 120.

The P-GW 123 may further be a node for policy enforcement and charging data collection. Policy and Charging Enforcement Function (PCRF) 126 is the policy and charging control element of the CN 120. In a non-roaming scenario, there may be a single PCRF in the Home Public Land Mobile Network (HPLMN) associated with a UE's Internet Protocol Connectivity Access Network (IP-CAN) session. In a roaming scenario with local breakout of traffic, there may be two PCRFs associated with a UE's IP-CAN session: a Home PCRF (H-PCRF) within a HPLMN and a Visited PCRF (V-PCRF) within a Visited Public Land Mobile Network (VPLMN). The PCRF 126 may be communicatively coupled to the application server 130 via the P-GW 123. The application server 130 may signal the PCRF 126 to indicate a new service flow and select the appropriate Quality of Service (QoS) and charging parameters. The PCRF 126 may provision this rule into a Policy and Charging Enforcement Function (PCEF) (not shown) with the appropriate traffic flow template (TFT) and QoS class of identifier (QCI), which commences the QoS and charging as specified by the application server 130.

The quantity of devices and/or networks illustrated in FIG. 1 is provided for explanatory purposes only. In practice, there may be additional devices and/or networks, fewer devices and/or networks, different devices and/or networks, or differently arranged devices and/or networks than illustrated in FIG. 1. Alternatively or additionally, one or more of the devices of environment 100 may perform one or more functions described as being performed by another one or more of the devices of environment 100. Furthermore, while “direct” connections are shown in FIG. 1, these connections should be interpreted as logical communication pathways, and in practice, one or more intervening devices (e.g., routers, gateways, modems, switches, hubs, etc.) may be present.

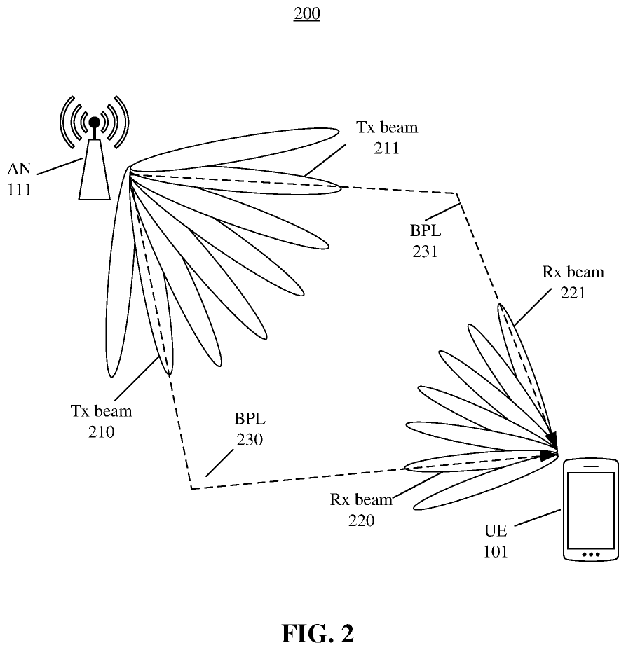

FIG. 2 shows an example for one or more BPLs between a UE and an access node in accordance with some embodiments of the disclosure. In the example of FIG. 2, the AN 111 may maintain a plurality of transmit (Tx) beams including a Tx beam 210 and a Tx beam 211, and the UE 101 may maintain a plurality of receive (Rx) beams including a Rx beam 220 and a Rx beam 221. There may be one or more BPLs between the AN 111 and UE 101, wherein each of the BPLs may be formed by a Tx beam of the AN 111 and a Rx beam of the UE 101. For example, as shown in FIG. 2, a BPL 230 may be formed by the Tx beam 210 of the AN 111 and the Rx beam 220 of the UE 101, and a BPL 231 may be formed by the Tx beam 211 of the AN 111 and the Rx beam 221 of the UE 101.

In an embodiment, the plurality of Tx beams of the AN 111 may be wide beams for an SS block, and in this case, if there are two BPLs of good beam quality (such as, the BPL 230 and the BPL 231) among all the BPLs between the AN 111 and UE 101, then the AN 111 may identify two coarse transmission directions, if there is only one BPL of good beam quality (such as, the BPL 230 or the BPL 231) among all the BPLs between the AN 111 and UE 101, then the AN 111 may identify only one coarse transmission direction, and if there is no BPL of good beam quality among all the BPLs between the AN 111 and UE 101, then the AN 111 may fail to identify any coarse transmission direction.

It should be understood that, the number of Tx beams of the AN 111, Rx beams of the UE 101 and/or BPLs between the AN 111 and the UE 101 illustrated in FIG. 2 is provided for explanatory purposes only and is not limited herein.

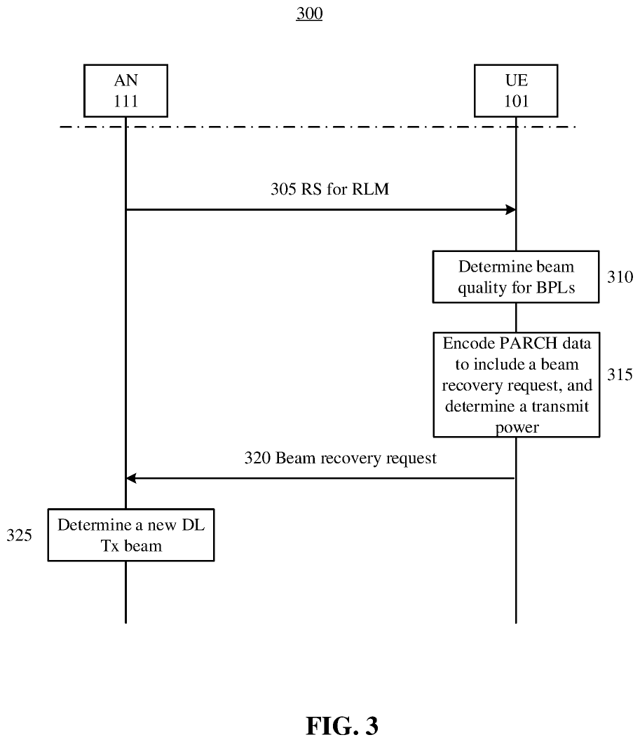

FIG. 3 is a flow chart showing operations for beam recovery in accordance with some embodiments of the disclosure. The operations of FIG. 3 may be used for a UE (e.g., UE 101) to encode a beam recovery request to an AN (e.g., AN 111) of a RAN (e.g., RAN 110) for beam recovery.

The AN 111 may process (e.g., modulate, encode, etc.) a Reference Signal (RS), and transmit, at 305, the processed RS to the UE 101 for radio link monitoring (RLM). In an embodiment, the RS may be transmitted with a beam sweeping operation. The RS may be a Synchronization Signal (SS) block or a Channel State Information Reference Signal (CSI-RS), which may be pre-defined or configured by a higher layer signaling. In an embodiment, an SS block may include a Primary SS (PSS), a secondary SS (SSS) and a Physical Broadcast Channel (PBCH). In an embodiment, an SS block may also include a Demodulation Reference Signal (DMRS) used for common control channel.

The UE 101 may receive the RS that the AN 111 transmitted at 305, and process (e.g., demodulate, decode, detect, etc.), at 310, the received RS to determine beam quality for one or more BPLs between the UE 101 and the AN 111 based on the processed RS. The beam quality for each of the BPLs may be determined by measuring a Signal to Interference plus Noise Ratio (SINR), a Reference Signal Receiving Power (RSRP) or Reference Signal Receiving Quality (RSRQ) of the processed RS for the BPL.

A first threshold may be configured by a higher layer signaling for determining whether the UE 101 needs to process (e.g., modulate, encode, etc.) a beam recovery request for transmission to the AN 111. In an embodiment, at 315, the UE 101 may process (e.g., modulate, encode, etc.) a beam recovery request if the beam quality for all of the BPLs is below the first threshold. In another embodiment, at 315, the UE 101 may process (e.g., modulate, encode, etc.) a beam recovery request if the beam quality for all of the BPLs is below the first threshold for a predetermined or configured time period.

Alternatively, in addition to the first threshold, a second threshold may also be configured by a higher layer signaling. In an embodiment, at 315, the UE 101 may process (e.g., modulate, encode, etc.) a beam recovery request to the AN 111 if the beam quality for all of the BPLs is below the first threshold and above the second threshold. In another embodiment, at 315, the UE 101 may process (e.g., modulate, encode, etc.) a beam recovery request if the beam quality for all of the BPLs is below the first threshold and above the second threshold for a predetermined or configured time period.

It is to be noted that, for the SS and CSI-RS, the thresholds discussed above may be the same or different.

At 315, in response to the beam quality for the BPLs meeting a predetermined or configured threshold requirement as described above for example, the UE 101 may process (e.g., modulate, encode, etc.) PRACH data to include a beam recovery request, wherein the beam recovery request identifies a new or candidate beam of the AN 111 for beam recovery, and determine a transmit power for the beam recovery request. In some embodiments, the UE 101 may choose the new or candidate beam of the AN 111 from a set of beams of AN 111, wherein the set of beams may be preconfigured by a higher layer signaling via New radio (NR) minimum system information (MSI), NR remaining minimum system information (RMSI), a NR system information block (SIB), or a radio resource control (RRC) signaling.

In some embodiments, the UE 101 may determine the transmit power based on a maximum transmit power for the UE 101, and a weight which is configured by a higher layer signaling. For example, the transmit power may be expressed as follows:

P_{Tx}=βP_{c,max} (1)

wherein P_{Tx} indicates the transmit power, P_{c,max} indicates a maximum transmit power for the UE 101, and β is a weight parameter which may be pre-defined or configured by a higher layer signaling, wherein 0<β≤1.

In some embodiments, the UE 101 may determine the transmit power based on a path loss between the UE 101 and the AN 111, a predetermined receive power for the AN 111 which is configured by a higher layer signaling, a weight which is configured by a higher layer signaling, and a predetermined power offset. For example, the transmit power may be expressed as follows:

P_{Tx}=min{αP_{L}−P₀+Δ_{offset},P_{c,max}} (2)

wherein P_{Tx} indicates the transmit power, P_{c,max} indicates a maximum transmit power for the UE 101, α is a weight parameter which may be pre-defined or configured by a higher layer signaling, wherein 0<α≤1, P_{L} indicates a path loss between the UE 101 and the AN 111, P₀ indicates a predetermined receive power for the AN 111 which may be pre-defined or configured by a higher layer signaling, and Δ_{offset} indicates a predetermined power offset which may be pre-defined or configured by the AN 111. In an embodiment, P_{L} which indicates a path loss between the UE 101 and the AN 111 may be calculated based on an averaging SINR, RSRP or RSRQ of some downlink beams that may be pre-defined or configured by a higher layer signaling. In an embodiment, Δ_{offset} which indicates the predetermined power offset may be a difference between a receive power of a current receive beam of the AN 111 and a receive power of a worse receive beam of the AN 111, if the current receive beam is known by the UE 101. In an embodiment, Δ_{offset} which indicates the predetermined power offset may be a difference between a receive power of a current receive beam of the AN 111 and a receive power of the new or candidate beam of the AN 111, if the current receive beam is known by the UE 101. In an embodiment, Δ_{offset} which indicates the predetermined power offset may be a difference between an average receive power of a subset of receive beams of the AN 111 and a receive power of the new or candidate beam of the AN 111.

In some embodiments, the UE 101 may determine the transmit power based on a transmit power of a previous uplink signal, and a predetermined power offset. For example, the transmit power may be expressed as follows:

P_{Tx}=min{Pₚᵣₑᵥᵢₒᵤₛ+Δ_{offset},P_{c,max}} (3)

wherein P_{Tx} indicates the transmit power, P_{c,max} indicates a maximum transmit power for the UE 101, Pₚᵣₑᵥᵢₒᵤₛ indicates a transmit power of a previous uplink signal, and Δ_{offset} indicates a predetermined power offset which may be pre-defined or configured by the AN 111. As discussed previously, in an embodiment, Δ_{offset} which indicates the predetermined power offset may be a difference between a receive power of a current receive beam of the AN 111 and a receive power of a worse receive beam of the AN 111, if the current receive beam is known by the UE 101. In an embodiment, Δ_{offset} which indicates the predetermined power offset may be a difference between a receive power of a current receive beam of the AN 111 and a receive power of the new or candidate beam of the AN 111, if the current receive beam is known by the UE 101. In an embodiment, Δ_{offset} which indicates the predetermined power offset may be a difference between an average receive power of a subset of receive beams of the AN 111 and a receive power of the new or candidate beam of the AN 111.

In some embodiments, the UE 101 may determine the transmit power based on a transmit power of a previous uplink signal, a first predetermined power offset, and a second predetermined power offset. For example, the transmit power may be expressed as follows:

P_{Tx}=min{Pₚᵣₑᵥᵢₒᵤₛ+Δ_{offset,1}+Δ_{offset,2},P_{c,max}} (4)

wherein P_{Tx} indicates the transmit power, P_{c,max} indicates a maximum transmit power for the UE 101, Pₚᵣₑᵥᵢₒᵤₛ indicates a transmit power of a previous uplink signal, and both Δ_{offset,1} and Δ_{offset,2} indicate a predetermined power offset which may be pre-defined or configured by the AN 111, wherein Δ_{offset,1} may be larger than Δ_{offset,2}, and Δ_{offset,1} may be used for making a major adjustment to the transmit power, while Δ_{offset,2} may be used for making a minor adjustment to the transmit power on the basis of Δ_{offset,1}.

As discussed previously, the UE 101 may determine the transmit power (for example, by using any of equations (1)-(4)) and transmit a PRACH (namely, transmit the beam recovery request) using the transmit power, so as to ensure the AN 111 to reliably receive the beam recovery request. In addition, the AN 111 may define multiple power offsets as described above for example, and the UE 101 may select a power offset according to a targeting time or frequency resource for transmission of a PRACH. The UE 101 may use a power offset to increase a transmit power for transmitting a PRACH carrying a beam recovery request, so as to ensure the AN 111 to reliably receive the beam recovery request.

It is to be noted that the above embodiments may also be used to calculate a transmit power for transmitting a PUCCH carrying a beam recovery request for beam recovery.

At 320, the UE 101 may transmit the PRACH data (namely, the beam recovery request) with the transmit power determined by the UE 101 at 315. The AN 111 may receive the beam recovery request that the UE 101 transmitted at 320, and process (e.g., demodulate, decode, detect, etc.), at 325, the new or candidate beam of the AN 111 based on the beam recovery request for subsequent transmission.

In some embodiments, the new or candidate beam of the AN 111 may be identified based on a time resource of the PRACH and/or a frequency resource of the PRACH. The time resource of the PRACH may be a symbol index, a slot index, a sub frame index, or a frame index of the PRACH. In an embodiment, the new or candidate beam of the AN 111 may be a beam for an SS block or a beam for a CSI-RS, and whether the new or candidate beam is a beam for an SS block or a beam for a CSI-RS may be determined by a time resource (e.g., a symbol index, a slot index, a sub frame index, or a frame index) of the PRACH and/or a frequency resource of the PRACH as described above. In an embodiment, beams for some slots of the PRACH may be one-to-one mapped to beams for SS blocks, and beams for some other slots of the PRACH may be one-to-one mapped to beams for CSI-RS.

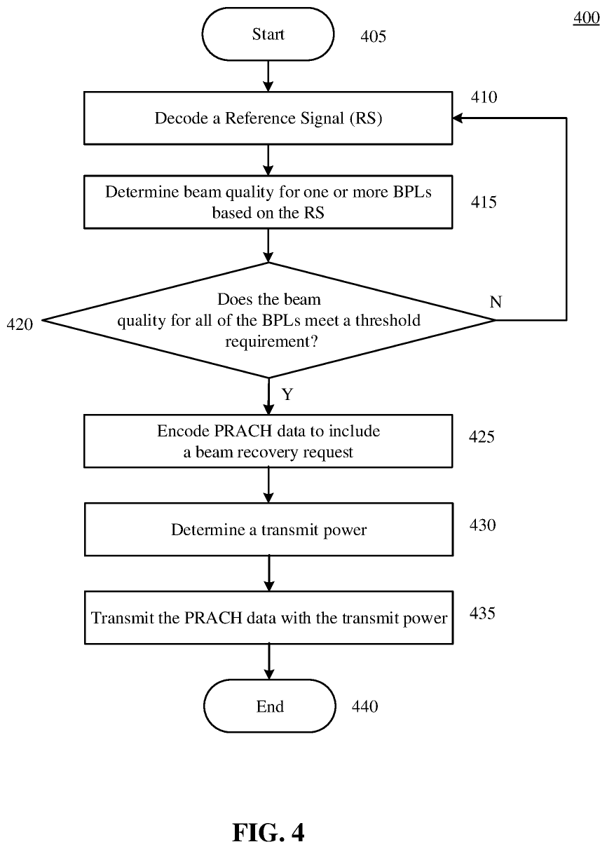

FIG. 4 is a flow chart showing a method performed by a UE for beam recovery in accordance with some embodiments of the disclosure. The operations of FIG. 4 may be used for a UE (e.g., UE 101) to encode a beam recovery request to an AN (e.g., AN 111) of a RAN (e.g., RAN 110) for beam recovery.

The method starts at 405. At 410, the UE 101 may process (e.g., demodulate, decode, detect, etc.) a RS received from the AN 111. At 415, the UE 101 may determine beam quality for one or more BPLs between the UE 101 and the AN 111 based on the processed RS. As discussed previously with reference to FIG. 3 in detail, the beam quality for the BPLs may be determined by measuring a SINR, a RSRP or RSRQ of the processed RS.

Then, the UE 101 may determine whether the beam quality for the BPLs meets a threshold requirement at 420. If not, the method may return back to 410, and if yes, the method may proceed to 425, where the UE 101 may process (e.g., modulate, encode, etc.) PRACH data to include a beam recovery request, wherein the beam recovery request identifies a new or candidate beam of the AN 111 for beam recovery. The threshold requirement may be configured by a higher layer signaling, as discussed previously with reference to FIG. 3 in detail.

The UE 101 may determine a transmit power (for example, by using any of equations (1)-(4)) at 430, and transmit the PRACH data (namely, transmit the beam recovery request) with the transmit power at 435, so as to ensure the AN 111 to reliably receive the beam recovery request. In addition, the AN 111 may define multiple power offsets as described above for example, and the UE 101 may select a power offset according to a targeting time or frequency resource for transmission of a PRACH. The UE 101 may use a power offset to increase a transmit power for transmitting a PRACH carrying a beam recovery request, so as to ensure the AN 111 to reliably receive the beam recovery request.

For the sake of brevity, some embodiments which have already been described with reference to FIG. 3 in detail will not be repeated. The method ends at 440.

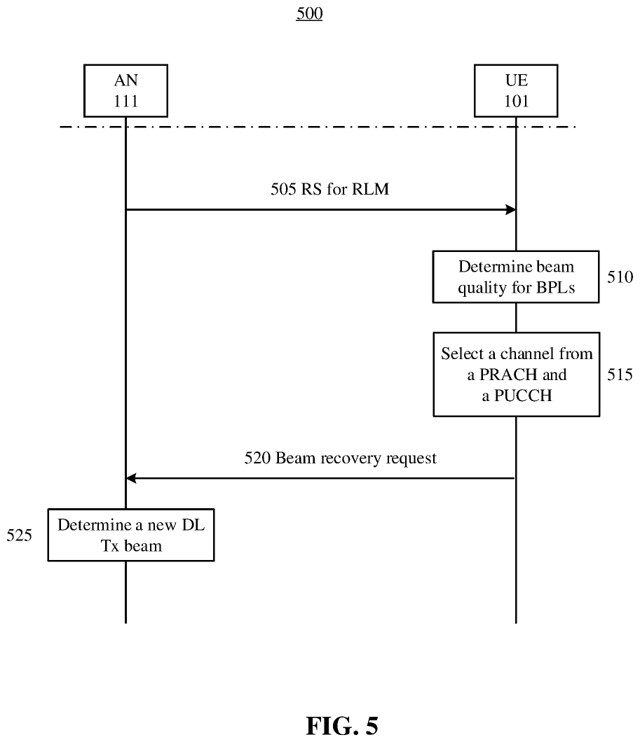

FIG. 5 is a flow chart showing operations for beam recovery in accordance with some embodiments of the disclosure. The operations of FIG. 5 may be used for a UE (e.g., UE 101) to encode a beam recovery request to an AN (e.g., AN 111) of a RAN (e.g., RAN 110) for beam recovery.

The AN 111 may process (e.g., modulate, encode, etc.) a RS, and transmit, at 505, the processed RS to the UE 101 for RLM. In an embodiment, the RS may be transmitted with a beam sweeping operation. The RS may be an SS block or a CSI-RS, which may be pre-defined or configured by a higher layer signaling. In an embodiment, an SS block may include a PSS, an SSS and a PBCH. In an embodiment, an SS block may also include a DMRS used for common control channel.

The UE 101 may receive the RS that the AN 111 transmitted at 505, and process (e.g., demodulate, decode, detect, etc.), at 510, the received RS to determine beam quality for one or more BPLs between the UE 101 and the AN 111 based on the processed RS. The beam quality for each of the BPLs may be determined by measuring a SINR, a RSRP or RSRQ of the processed RS for the BPL.

A first threshold may be configured by a higher layer signaling for determining whether the UE 101 needs to select a channel from a PRACH and a PUCCH for transmission of a beam recovery request that identifies a candidate beam of the access node, and then the UE 101 may process (e.g., modulate, encode, etc.) the beam recovery request for transmission via the selected channel to the AN 111. In an embodiment, the UE 101 may select a channel at 515 if the beam quality for all of the BPLs is below the first threshold, and then process (e.g., modulate, encode, etc.) a beam recovery request for transmission via the selected channel to the AN 111. In another embodiment, the UE 101 may select a channel at 515 if the beam quality for all of the BPLs is below the first threshold for a predetermined or configured time period, and then process (e.g., modulate, encode, etc.) a beam recovery request for transmission via the selected channel to the AN 111.

Alternatively, in addition to the first threshold, a second threshold may also be configured by a higher layer signaling. In an embodiment, the UE 101 may select a channel at 515 if the beam quality for all of the BPLs is below the first threshold and above the second threshold, and then process (e.g., modulate, encode, etc.) a beam recovery request for transmission via the selected channel to the AN 111. In another embodiment, the UE 101 may select a channel at 515 if the beam quality for all of the BPLs is below the first threshold and above the second threshold for a predetermined or configured time period, and then process (e.g., modulate, encode, etc.) a beam recovery request for transmission via the selected channel to the AN 111.

It is to be noted that, for the SS and CSI-RS, the thresholds discussed above may be the same or different.

In selecting a channel from a PRACH and a PUCCH at 515, in some embodiments, the UE 101 may first determine a SINR, a RSRP or RSRQ of the processed RS, and then the UE 101 may select the PRACH when the SINR, RSRP or RSRQ is higher than a third predetermined threshold, and select the PUCCH when the SINR, RSRP or RSRQ is lower than the third predetermined threshold. In an embodiment, the SINR, RSRP or RSRQ of the processed RS may be an average SINR, RSRP or RSRQ of the processed RS for the one or more BPLs between the UE 101 and the AN 111. In another embodiment, the SINR, RSRP or RSRQ of the processed RS may be an average SINR, RSRP or RSRQ of the processed RS for one or more BPLs among the one or more BPLs between the UE 101 and the AN 111.

In selecting a channel from a PRACH and a PUCCH at 515, in some embodiments, the UE 101 may first determine whether the new or candidate beam of the AN 111 and a current receive beam of the AN 111 is within a same group which may be preconfigured by a higher layer signaling, and then select the PRACH when it is determined that the new or candidate beam and the current receive beam is within the same group, and select the PUCCH when it is determined that the new or candidate beam and the current receive beam is not within the same group. In an embodiment, beams within a same group may have a high correlation (for example, are close to each other), and beams not within a same group may have a low correlation (for example, are far away from each other).

As described above, there are two ways (using a PRACH or PUCCH) to transmit a beam recovery request. Compared with using a PUCCH, using a PRACH may effectively save the system resources due to no need to explicitly transmit a message to inform the AN 111 of a new or candidate beam of the AN 111 for beam recovery. However, the PRACH may not be successfully received due to a bad receive beam without beam correspondence. At least some embodiments described above allow for determining a proper transmission power to transmit a PRACH carrying a beam recovery request when there is no beam correspondence, so as to ensure an access node to reliably receive the PRACH for beam recovery. In addition, at least some embodiments described above allow for determining whether to use a PRACH or a PUCCH to transmit a beam recovery request is a better choice for different cases.

At 520, the UE 101 may transmit the beam recovery request via a channel selected by the UE 101 at 515. The AN 111 may receive the beam recovery request that the UE 101 transmitted at 520, and process (e.g., demodulate, decode, detect, etc.), at 525, the new or candidate beam of the AN 111 based on the beam recovery request for subsequent transmission.

In some embodiments, the beam recovery request is transmitted via the PUCCH, and this case, the new or candidate beam of the AN 111 may be processed based on a new or candidate beam index carried by the PUCCH. In an embodiment, the new or candidate beam index may be a beam index of a beam for an SS block or a beam index of a beam for a CSI-RS. The beam index of the beam for the SS block may be a timing index carried by a Demodulation Reference Signal (DMRS) of a Physical Broadcast Channel (PBCH) of the SS block, and the beam index of the beam for the CSI-RS may be an antenna port index of the CSI-RS or a CSI-RS resource index (CRI). In an embodiment, a beam index of each of beams for SS block(s) and a beam index of each of beams for CSI-RS may be jointly encoded. For example, beam index 0 to M−1 may indicate M beams for SS block(s) and beam index M to N−1 (N>=M) may indicate N-M beams for CSI-RS. In an embodiment, different PUCCH resources may be allocated for different use cases, for example, some PUCCH resources (which may be PUCCH format x for example) may be used for a beam recovery which is based on a new or candidate beam for an SS block, and some other PUCCH resources (which may be PUCCH format y for example) may be used for a beam recovery which is based on a new or candidate beam for a CSI-RS.

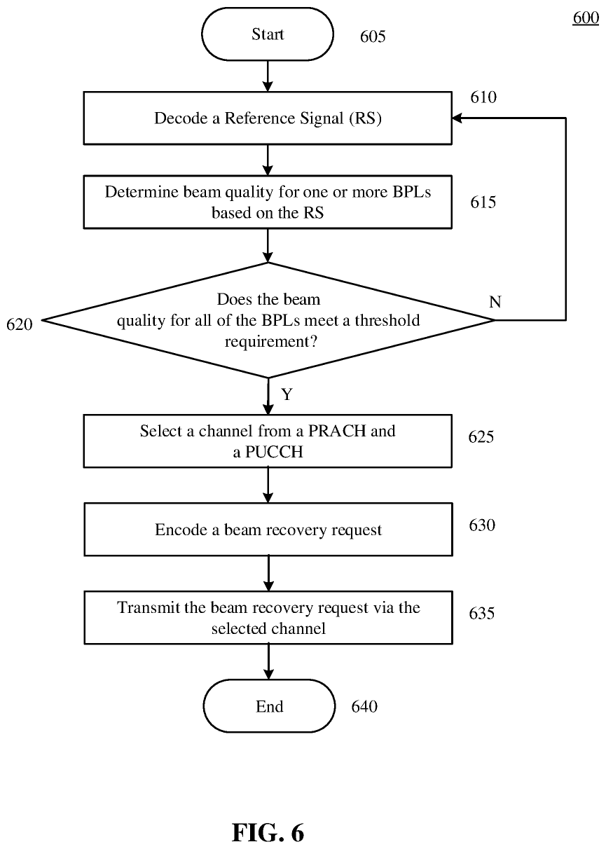

FIG. 6 is a flow chart showing a method performed by a UE for beam recovery in accordance with some embodiments of the disclosure. The operations of FIG. 6 may be used for a UE (e.g., UE 101) to encode a beam recovery request to an AN (e.g., AN 111) of a RAN (e.g., RAN 110) for beam recovery.

The method starts at 605. At 610, the UE 101 may process (e.g., demodulate, decode, detect, etc.) a RS received from the AN 111. At 615, the UE 101 may determine beam quality for one or more BPLs between the UE 101 and the AN 111 based on the processed RS. As discussed previously with reference to FIG. 3 or 5 in detail, the beam quality for the BPLs may be determined by measuring a SINR, a RSRP or RSRQ of the processed RS.

Then, the UE 101 may determine whether the beam quality for the BPLs meets a threshold requirement at 620. If not, the method may return back to 610, and if yes, the method may proceed to 625, where the UE 101 may select a channel from a PRACH and a PUCCH for transmission of a beam recovery request that identifies a candidate beam of the access node, and then at 630, the UE 101 may process (e.g., modulate, encode, etc.) the beam recovery request for transmission via the selected channel to the AN 111. The threshold requirement may be configured by a higher layer signaling, as discussed previously with reference to FIG. 3 or 5 in detail.

In selecting a channel from a PRACH and a PUCCH at 625, in some embodiments, the UE 101 may first determine a SINR, a RSRP or RSRQ of the processed RS, and then the UE 101 may select the PRACH when the SINR, RSRP or RSRQ is higher than a third predetermined threshold, and select the PUCCH when the SINR, RSRP or RSRQ is lower than the third predetermined threshold. In an embodiment, the SINR, RSRP or RSRQ of the processed RS may be an average SINR, RSRP or RSRQ of the processed RS for the one or more BPLs between the UE 101 and the AN 111. In another embodiment, the SINR, RSRP or RSRQ of the processed RS may be an average SINR, RSRP or RSRQ of the processed RS for one or more BPLs among the one or more BPLs between the UE 101 and the AN 111.

In selecting a channel from a PRACH and a PUCCH at 625, in some embodiments, the UE 101 may first determine whether the new or candidate beam of the AN 111 and a current receive beam of the AN 111 is within a same group which may be preconfigured by a higher layer signaling, and then select the PRACH when it is determined that the new or candidate beam and the current receive beam is within the same group, and select the PUCCH when it is determined that the new or candidate beam and the current receive beam is not within the same group. In an embodiment, beams within a same group may have a high correlation (for example, are close to each other), and beams not within a same group may have a low correlation (for example, are far away from each other).

As described above, there are two ways (using a PRACH or PUCCH) to transmit a beam recovery request. Compared with using a PUCCH, using a PRACH may effectively save the system resources due to no need to explicitly transmit a message to inform the AN 111 of a new or candidate beam of the AN 111 for beam recovery. However, the PRACH may not be successfully received due to a bad receive beam without beam correspondence. At least some embodiments described above allow for determining a proper transmission power to transmit a PRACH carrying a beam recovery request when there is no beam correspondence, so as to ensure an access node to reliably receive the PRACH for beam recovery. In addition, at least some embodiments described above allow for determining whether to use a PRACH or a PUCCH to transmit a beam recovery request is a better choice for different cases.

At 635, the UE 101 may transmit the beam recovery request via the selected channel. For the sake of brevity, some embodiments which have already been described with reference to FIG. 5 in detail will not be repeated. The method ends at 640.

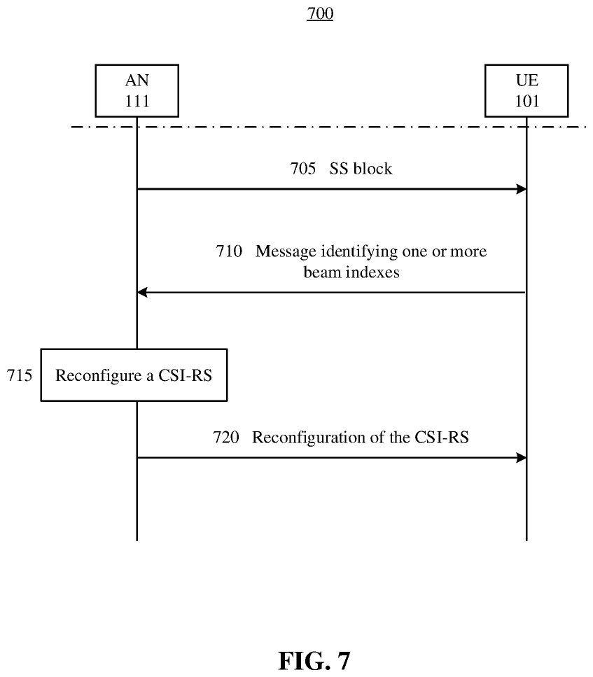

FIG. 7 is a flow chart showing operations for reconfiguration of a CSI-RS in accordance with some embodiments of the disclosure. The operations of FIG. 7 may be used for an AN (e.g., AN 111) of a RAN (e.g., RAN 110) to reconfigure a CSI-RS based on a message received from a UE (e.g., UE 101).

The AN 111 may process (e.g., modulate, encode, etc.) an SS block, and then transmit, at 705, the SS Block to the UE 101. In an embodiment, the SS block may be transmitted with a beam sweeping operation. In an embodiment, the SS block may include a Primary SS (PSS), a secondary SS (SSS) and a Physical Broadcast Channel (PBCH).

The UE 101 may receive the SS block that the AN 111 transmitted at 705 and process (e.g., demodulate, decode, detect, etc.) the received SS block, and then process (e.g., modulate, encode, etc.) a message based on the processed SS block for transmission to the AN 111 at 710, wherein the message may identify one or more beam indexes of one or more beams of the AN 111 for the SS block. The UE 101 may inform the AN 111 regarding one or more coarse transmission directions (namely, one or more wide beams applied in the SS block) based on the one or more beam indexes identified by the message. The UE 101 may recommend the AN 111 to update one or more coarse transmission directions (to add one or more new coarse transmission directions, and/or to remove one or more existing coarse transmission directions) based on the one or more beam indexes identified by the message. In an embodiment, each of the beam indexes may be a timing index carried by a Demodulation Reference Signal (DMRS) of a Physical Broadcast Channel (PBCH) of the SS block for a corresponding beam.

In some embodiments, the UE 101 may first determine beam quality of the one or more beams based on the processed SS block before processing (e.g., modulating, encoding, etc.) the message, and then process (e.g., modulate, encode, etc.) the message based on the beam quality, and wherein the message may further identify the beam quality of the one or more beams. In an embodiment, the UE 101 may process (e.g., modulate, encode, etc.) the message based on the beam quality in a periodic manner, a semi-persistent manner, or an aperiodic manner. The beam quality of each of the one or more beams (namely, beam quality for each of one or more BPLs corresponding to the one or more beams) may be determined by measuring a SINR, a RSRP or RSRQ of the processed SS block for the corresponding beam.

In some embodiments, the UE 101 may first determine beam quality of the one or more beams based on the processed SS block before processing (e.g., modulating, encoding, etc.) the message, and then process (e.g., modulate, encode, etc.) the message based on the beam quality. The beam quality of each of the one or more beams (namely, beam quality for each of one or more BPLs corresponding to the one or more beams) may be determined by measuring a SINR, a RSRP or RSRQ of the processed SS block for the corresponding beam. In an embodiment, the message may be encoded via a Physical Uplink Control Channel (PUCCH), or via a higher layer signaling, such as a Medium Access Control (MAC) Control Element (CE) or a Radio Resource Control (RRC) signaling. In this case, the one or more beam indexes identified by the message may be indicated explicitly by a payload of the PUCCH, or a higher layer signaling. In another embodiment, one of the one or more beam indexes for the SS block identified by the message may be indicated implicitly by a Quasi-Co-Located (QCL) relationship between a beam index for a CSI-RS and a beam index for the SS block.

In some embodiments, the message may be a beam recovery request. In this case, the UE 101 may first determine beam quality for one or more BPLs between the UE 101 and the AN 111 based on the processed SS block before processing (e.g., modulating, encoding, etc.) the message (namely, a beam recovery request). The beam quality for each of the BPLs may be determined by measuring a SINR, a RSRP or RSRQ of the processed SS block for the BPL.

In an embodiment, a first threshold may be configured by a higher layer signaling for determining whether the UE 101 needs to process (e.g., modulate, encode, etc.) a beam recovery request for transmission to the AN 111. In an embodiment, the UE 101 may process (e.g., modulate, encode, etc.) a beam recovery request if the beam quality for all of the BPLs is below the first threshold, and then transmit the beam recovery request to the AN 111 at 710. In another embodiment, the UE 101 may process (e.g., modulate, encode, etc.) a beam recovery request if the beam quality for all of the BPLs is below the first threshold for a predetermined or configured time period, and then transmit the beam recovery request to the AN 111 at 710.

Alternatively, in addition to the first threshold, a second threshold may also be configured by a higher layer signaling. In an embodiment, the UE 101 may process (e.g., modulate, encode, etc.) a beam recovery request if the beam quality for all of the BPLs is below the first threshold and above the second threshold, and then transmit the beam recovery request to the AN 111 at 710. In another embodiment, the UE 101 may process (e.g., modulate, encode, etc.) a beam recovery request if the beam quality for all of the BPLs is below the first threshold and above the second threshold for a predetermined or configured time period, and then transmit the beam recovery request to the AN 111 at 710.

In an embodiment, the beam recovery request may be encoded via a Physical Random Access Channel (PRACH) or a Physical Uplink Control Channel (PUCCH), and thus the one or more beam indexes identified by the beam recovery request may be indicated implicitly by time or frequency resources of the PRACH or explicitly by a payload of the PUCCH. In an embodiment, the beam recovery request may carry some information on the beam quality for the one or more BPLs. For example, if the beam recovery request is encoded via a PUCCH, then the information on the beam quality may be quantized into N bits and then be included in the beam recovery request, and if the beam recovery request is encoded via a PRACH, then preamble indexes of the PRACH may be divided into N groups and the group indexes may be used to quantize the information on the beam quality.

The AN 111 may receive the message that the UE 101 transmitted at 710, and process (e.g., demodulate, decode, detect, etc.) the received message, and then update a configuration of a CSI-RS (namely, reconfigure the CSI-RS) based on the processed message at 715. The AN 111 may first identify one or more coarse transmission directions (namely, one or more wide beams applied in the SS block) based on the one or more beam indexes identified by the message, and then update a configuration of a CSI-RS (namely, reconfigure the CSI-RS) based on the one or more coarse transmission directions. In an embodiment, the AN 111 may first update one or more coarse transmission directions (add one or more new coarse transmission directions, and/or remove one or more existing coarse transmission directions) based on the one or more beam indexes identified by the message, and then update a configuration of a CSI-RS (namely, reconfigure the CSI-RS) based on the updated one or more coarse transmission directions.

In an embodiment, the AN 111 may reconfigure one or more beams of the AN 111 for the CSI-RS around the one or more coarse transmission directions, namely, around the one or more beams of the AN 111 for the SS block. In an embodiment, the configuration of the CSI-RS may include at least one of the number of resources for the CSI-RS, a setting of resources for the CSI-RS, an index of each of resources for the CSI-RS, and a periodicity of the CSI-RS.

The AN 111 may process (e.g., modulate, encode, etc.) the updated configuration of the CSI-RS for transmission to the UE 101 at 720. In an embodiment, after receiving the message transmitted by the UE 101 at 710, the AN 111 may respond to the UE 101 with the updated configuration of the CSI-RS within a configured time window.

In addition, although not shown in FIG. 7, the AN 111 may further process (e.g., modulate, encode, etc.) the CSI-RS and transmit the CSI-RS to the UE 101. Then the UE 101 may receive and process (e.g., demodulate, decode, detect, etc.) the CSI-RS transmitted by the AN 111 to determine beam quality for one or more BPLs of the CSI-RS between the AN 111 and the UE 101, and then process (e.g., modulate, encode, etc.) a message based on the beam quality for transmission to the AN 111, wherein the message may identify the beam quality for the one or more BPLs of the CSI-RS between the AN 111 and the UE 101. The AN 111 may receive and process (e.g., demodulate, decode, detect, etc.) the message from the UE 101, and finally identify, based on the beam quality identified by the message, one or more beams (namely, one or more narrow beams applied in the CSI-RS around the coarse transmission directions) for transmission (such as, for a data and/or control channel). The beam quality for each of the BPLs may be determined by measuring a SINR, a RSRP or RSRQ of the processed CSI-RS for the BPL. In this case, the AN 111 may identify one or more beams, based on a CSI-RS, for use in transmission, and thus the identified one or more beams for use in transmission are one or more beams for CSI-RS. However, the present disclosure is not limited in this respect. In some embodiments, the AN 111 may identify one or more beams, directly based on an SS block, for use in transmission, so as to reduce the overhead. In some embodiments, the AN 111 may identify one or more beams, based on both an SS block and a CSI-RS, for use in transmission. Actually, in some embodiments, the AN 111 may configure whether one or more beams for use in transmission is identified based on an SS block or a CSI-RS, or both.

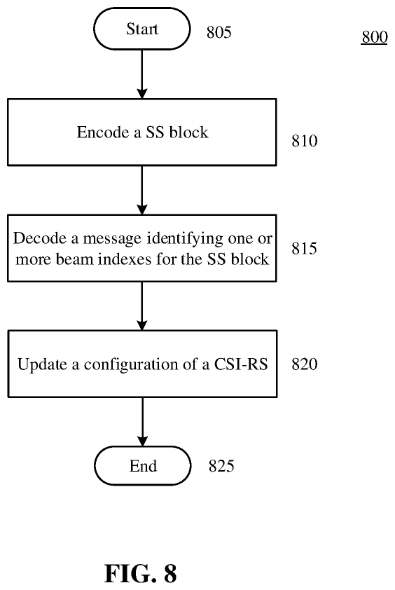

FIG. 8 is a flow chart showing a method performed by an access node for reconfiguration of a CSI-RS in accordance with some embodiments of the disclosure. The operations of FIG. 8 may be used for an AN (e.g., AN 111) of a RAN (e.g., RAN 110) to reconfigure a CSI-RS based on a message received from a UE (e.g., UE 101).

The method starts at 805. At 810, the AN 111 may process (e.g., modulate, encode, etc.) an SS block and transmit the SS Block to the UE 101. In an embodiment, the SS block may be transmitted with a beam sweeping operation. In an embodiment, the SS block may include a Primary SS (PSS), a secondary SS (SSS) and a Physical Broadcast Channel (PBCH).

At 815, the AN 111 may receive and process (e.g., demodulate, decode, detect, etc.) a message received from the UE 101, wherein the message may identify one or more beam indexes of one or more beams of the AN 111 for the SS block. As discussed previously with reference to FIG. 7 in detail, in an embodiment, each of the beam indexes may be a timing index carried by a Demodulation Reference Signal (DMRS) of a Physical Broadcast Channel (PBCH) of the SS block for a corresponding beam. In an embodiment, the message may be decoded via a PUCCH, a MAC CE, or a RRC signaling received from the UE 101. In an embodiment, the message may be a beam recovery request, and the beam recovery request may be decoded via a PRACH or a PUCCH received from the UE.

At 820, the AN 111 may update a configuration of a CSI-RS (namely, reconfigure the CSI-RS) based on the processed message. The AN 111 may first identify one or more coarse transmission directions (namely, one or more wide beams applied in the SS block) based on the one or more beam indexes identified by the message, and then update a configuration of a CSI-RS (namely, reconfigure the CSI-RS) based on the one or more coarse transmission directions. In an embodiment, the AN 111 may first update one or more coarse transmission directions (add one or more new coarse transmission directions, and/or remove one or more existing coarse transmission directions) based on the one or more beam indexes identified by the message, and then update a configuration of a CSI-RS (namely, reconfigure the CSI-RS) based on the updated one or more coarse transmission directions.

In an embodiment, the AN 111 may reconfigure one or more beams of the AN 111 for the CSI-RS around the one or more coarse transmission directions, namely, around the one or more beams of the AN 111 for the SS block. In an embodiment, the configuration of the CSI-RS may include at least one of the number of resources for the CSI-RS, a setting of resources for the CSI-RS, an index of each of resources for the CSI-RS, and a periodicity of the CSI-RS. In an embodiment, the AN 111 may process (e.g., modulate, encode, etc.) the updated configuration of the CSI-RS for transmission to the UE 101. The method ends at 825.

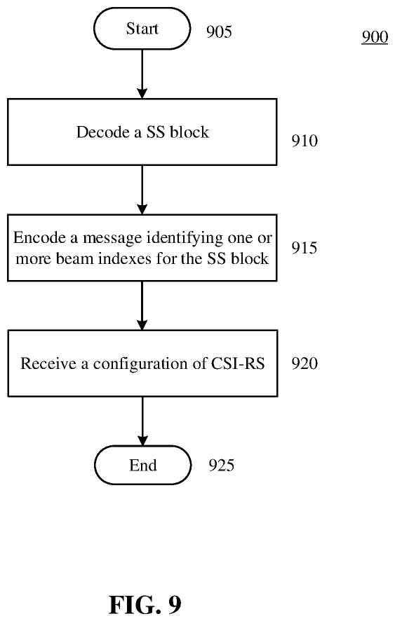

FIG. 9 is a flow chart showing a method performed by a UE for reconfiguration of a CSI-RS in accordance with some embodiments of the disclosure. The operations of FIG. 9 may be used for a UE (e.g., UE 101) to assist an AN (e.g., AN 111) of a RAN (e.g., RAN 110) to reconfigure a CSI-RS.

The method starts at 905. At 910, the UE 101 may receive and process (e.g., demodulate, decode, detect, etc.) the SS block transmitted by the AN 111.

At 915, the UE 101 may process (e.g., modulate, encode, etc.) a message based on the processed SS block for transmission to the AN 111, wherein the message may identify one or more beam indexes of one or more beams of the AN 111 for the SS block. As discussed previously with reference to FIG. 7 in detail, the UE 101 may inform the AN 111 regarding one or more coarse transmission directions (namely, one or more wide beams applied in the SS block) based on the one or more beam indexes identified by the message. The UE 101 may recommend the AN 111 to update one or more coarse transmission directions (to add one or more new coarse transmission directions, and/or to remove one or more existing coarse transmission directions) based on the one or more beam indexes identified by the message. In an embodiment, each of the beam indexes may be a timing index carried by a DMRS of a PBCH of the SS block for a corresponding beam.

In some embodiments, the UE 101 may first determine beam quality of the one or more beams based on the processed SS block before processing (e.g., modulating, encoding, etc.) the message, and then process (e.g., modulate, encode, etc.) the message based on the beam quality, and wherein the message may further identify the beam quality of the one or more beams. The beam quality of each of the one or more beams (namely, beam quality for each of one or more BPLs corresponding to the one or more beams) may be determined by measuring a SINR, a RSRP or RSRQ of the processed SS block for the corresponding beam. In an embodiment, the message may be encoded via a PUCCH, or via a higher layer signaling, such as a MAC CE or a RRC signaling. In some embodiments, the message may be a beam recovery request. In an embodiment, the beam recovery request may be encoded via a PRACH or a PUCCH.

At 920, the UE 101 may receive and process (e.g., demodulate, decode, detect, etc.) a configuration of a CSI-RS transmitted by the AN 111. In an embodiment, in the processed configuration, one or more beams of the AN 111 for the CSI-RS may be around the one or more beams of the AN 111 for the SS block. In an embodiment, the configuration of the CSI-RS may include at least one of the number of resources for the CSI-RS, a setting of resources for the CSI-RS, an index of each of resources for the CSI-RS, and a periodicity of the CSI-RS.

For the sake of brevity, some embodiments which have already been described with reference to FIG. 7 will not be repeated in detail. The method ends at 925.

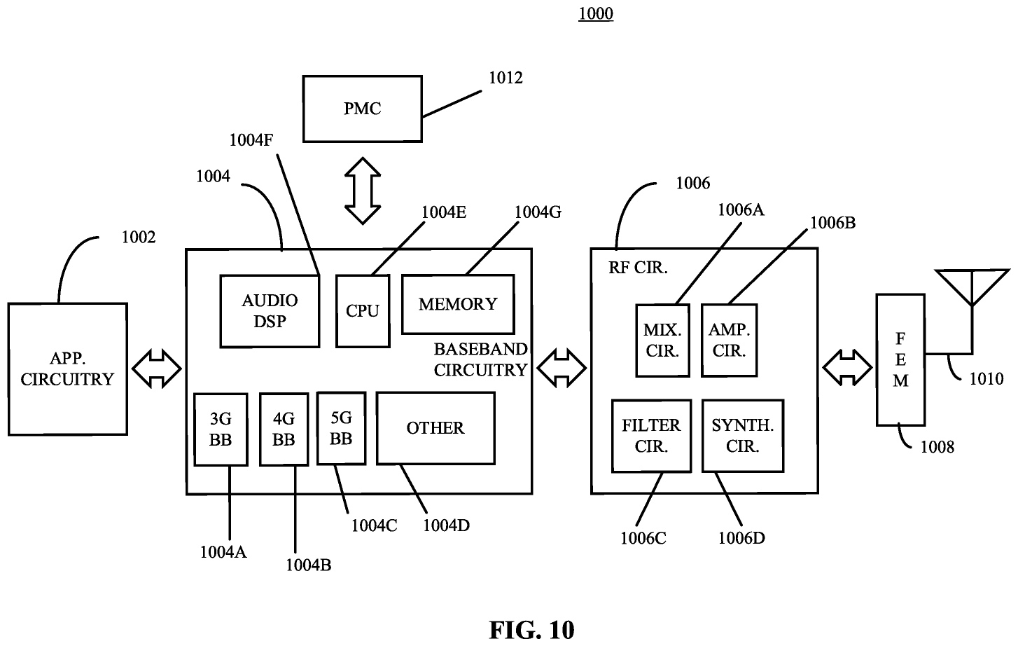

FIG. 10 illustrates example components of a device 1000 in accordance with some embodiments. In some embodiments, the device 1000 may include application circuitry 1002, baseband circuitry 1004, Radio Frequency (RF) circuitry 1006, front-end module (FEM) circuitry 1008, one or more antennas 1010, and power management circuitry (PMC) 1012 coupled together at least as shown. The components of the illustrated device 1000 may be included in a UE or an AN. In some embodiments, the device 1000 may include less elements (e.g., an AN may not utilize application circuitry 1002, and instead include a processor/controller to process IP data received from an EPC). In some embodiments, the device 1000 may include additional elements such as, for example, memory/storage, display, camera, sensor, or input/output (I/O) interface. In other embodiments, the components described below may be included in more than one device (e.g., said circuitries may be separately included in more than one device for Cloud-RAN (C-RAN) implementations).

The application circuitry 1002 may include one or more application processors. For example, the application circuitry 1002 may include circuitry such as, but not limited to, one or more single-core or multi-core processors. The processor(s) may include any combination of general-purpose processors and dedicated processors (e.g., graphics processors, application processors, etc.). The processors may be coupled with or may include memory/storage and may be configured to execute instructions stored in the memory/storage to enable various applications or operating systems to run on the device 1000. In some embodiments, processors of application circuitry 1002 may process IP data packets received from an EPC.

The baseband circuitry 1004 may include circuitry such as, but not limited to, one or more single-core or multi-core processors. The baseband circuitry 1004 may include one or more baseband processors or control logic to process baseband signals received from a receive signal path of the RF circuitry 1006 and to generate baseband signals for a transmit signal path of the RF circuitry 1006. Baseband processing circuitry 1004 may interface with the application circuitry 1002 for generation and processing of the baseband signals and for controlling operations of the RF circuitry 1006. For example, in some embodiments, the baseband circuitry 1004 may include a third generation (3G) baseband processor 1004A, a fourth generation (4G) baseband processor 1004B, a fifth generation (5G) baseband processor 1004C, or other baseband processor(s) 1004D for other existing generations, generations in development or to be developed in the future (e.g., second generation (2G), sixth generation (6G), etc.). The baseband circuitry 1004 (e.g., one or more of baseband processors 1004A-D) may handle various radio control functions that enable communication with one or more radio networks via the RF circuitry 1006. In other embodiments, some or all of the functionality of baseband processors 1004A-D may be included in modules stored in the memory 1004G and executed via a Central Processing Unit (CPU) 1004E. The radio control functions may include, but are not limited to, signal modulation/demodulation, encoding/decoding, radio frequency shifting, etc. In some embodiments, modulation/demodulation circuitry of the baseband circuitry 1004 may include Fast-Fourier Transform (FFT), precoding, or constellation mapping/demapping functionality. In some embodiments, encoding/decoding circuitry of the baseband circuitry 1004 may include convolution, tail-biting convolution, turbo, Viterbi, or Low Density Parity Check (LDPC) encoder/decoder functionality. Embodiments of modulation/demodulation and encoder/decoder functionality are not limited to these examples and may include other suitable functionality in other embodiments.

In some embodiments, the baseband circuitry 1004 may include one or more audio digital signal processor(s) (DSP) 1004F. The audio DSP(s) 1004F may include elements for compression/decompression and echo cancellation and may include other suitable processing elements in other embodiments. Components of the baseband circuitry may be suitably combined in a single chip, a single chipset, or disposed on a same circuit board in some embodiments. In some embodiments, some or all of the constituent components of the baseband circuitry 1004 and the application circuitry 1002 may be implemented together such as, for example, on a system on a chip (SOC).

In some embodiments, the baseband circuitry 1004 may provide for communication compatible with one or more radio technologies. For example, in some embodiments, the baseband circuitry 1004 may support communication with an evolved universal terrestrial radio access network (EUTRAN) or other wireless metropolitan area networks (WMAN), a wireless local area network (WLAN), a wireless personal area network (WPAN). Embodiments in which the baseband circuitry 1004 is configured to support radio communications of more than one wireless protocol may be referred to as multi-mode baseband circuitry.

RF circuitry 1006 may enable communication with wireless networks using modulated electromagnetic radiation through a non-solid medium. In various embodiments, the RF circuitry 1006 may include switches, filters, amplifiers, etc. to facilitate the communication with the wireless network. RF circuitry 1006 may include a receive signal path which may include circuitry to down-convert RF signals received from the FEM circuitry 1008 and provide baseband signals to the baseband circuitry 1004. RF circuitry 1006 may also include a transmit signal path which may include circuitry to up-convert baseband signals provided by the baseband circuitry 1004 and provide RF output signals to the FEM circuitry 1008 for transmission.

In some embodiments, the receive signal path of the RF circuitry 1006 may include mixer circuitry 1006a, amplifier circuitry 1006b and filter circuitry 1006c. In some embodiments, the transmit signal path of the RF circuitry 1006 may include filter circuitry 1006c and mixer circuitry 1006a. RF circuitry 1006 may also include synthesizer circuitry 1006d for synthesizing a frequency for use by the mixer circuitry 1006a of the receive signal path and the transmit signal path. In some embodiments, the mixer circuitry 1006a of the receive signal path may be configured to down-convert RF signals received from the FEM circuitry 1008 based on the synthesized frequency provided by synthesizer circuitry 1006d. The amplifier circuitry 1006b may be configured to amplify the down-converted signals and the filter circuitry 1006c may be a low-pass filter (LPF) or band-pass filter (BPF) configured to remove unwanted signals from the down-converted signals to generate output baseband signals. Output baseband signals may be provided to the baseband circuitry 1004 for further processing. In some embodiments, the output baseband signals may be zero-frequency baseband signals, although this is not a requirement. In some embodiments, mixer circuitry 1006a of the receive signal path may comprise passive mixers, although the scope of the embodiments is not limited in this respect.

In some embodiments, the mixer circuitry 1006a of the transmit signal path may be configured to up-convert input baseband signals based on the synthesized frequency provided by the synthesizer circuitry 1006d to generate RF output signals for the FEM circuitry 1008. The baseband signals may be provided by the baseband circuitry 1004 and may be filtered by filter circuitry 1006c.

In some embodiments, the mixer circuitry 1006a of the receive signal path and the mixer circuitry 1006a of the transmit signal path may include two or more mixers and may be arranged for quadrature downconversion and upconversion, respectively. In some embodiments, the mixer circuitry 1006a of the receive signal path and the mixer circuitry 1006a of the transmit signal path may include two or more mixers and may be arranged for image rejection (e.g., Hartley image rejection). In some embodiments, the mixer circuitry 1006a of the receive signal path and the mixer circuitry 1006a may be arranged for direct downconversion and direct upconversion, respectively. In some embodiments, the mixer circuitry 1006a of the receive signal path and the mixer circuitry 1006a of the transmit signal path may be configured for super-heterodyne operation.

In some embodiments, the output baseband signals and the input baseband signals may be analog baseband signals, although the scope of the embodiments is not limited in this respect. In some alternate embodiments, the output baseband signals and the input baseband signals may be digital baseband signals. In these alternate embodiments, the RF circuitry 1006 may include analog-to-digital converter (ADC) and digital-to-analog converter (DAC) circuitry and the baseband circuitry 1004 may include a digital baseband interface to communicate with the RF circuitry 1006.

In some dual-mode embodiments, a separate radio IC circuitry may be provided for processing signals for each spectrum, although the scope of the embodiments is not limited in this respect.

In some embodiments, the synthesizer circuitry 1006d may be a fractional-N synthesizer or a fractional N/N+1 synthesizer, although the scope of the embodiments is not limited in this respect as other types of frequency synthesizers may be suitable. For example, synthesizer circuitry 1006d may be a delta-sigma synthesizer, a frequency multiplier, or a synthesizer comprising a phase-locked loop with a frequency divider.

The synthesizer circuitry 1006d may be configured to synthesize an output frequency for use by the mixer circuitry 1006a of the RF circuitry 1006 based on a frequency input and a divider control input. In some embodiments, the synthesizer circuitry 1006d may be a fractional N/N+1 synthesizer.

In some embodiments, frequency input may be provided by a voltage controlled oscillator (VCO), although that is not a requirement. Divider control input may be provided by either the baseband circuitry 1004 or the applications processor 1002 depending on the desired output frequency. In some embodiments, a divider control input (e.g., N) may be determined from a look-up table based on a channel indicated by the applications processor 1002.

Synthesizer circuitry 1006d of the RF circuitry 1006 may include a divider, a delay-locked loop (DLL), a multiplexer and a phase accumulator. In some embodiments, the divider may be a dual modulus divider (DMD) and the phase accumulator may be a digital phase accumulator (DPA). In some embodiments, the DMD may be configured to divide the input signal by either N or N+1 (e.g., based on a carry out) to provide a fractional division ratio. In some example embodiments, the DLL may include a set of cascaded, tunable, delay elements, a phase detector, a charge pump and a D-type flip-flop. In these embodiments, the delay elements may be configured to break a VCO period up into Nd equal packets of phase, where Nd is the number of delay elements in the delay line. In this way, the DLL provides negative feedback to help ensure that the total delay through the delay line is one VCO cycle.

In some embodiments, synthesizer circuitry 1006d may be configured to generate a carrier frequency as the output frequency, while in other embodiments, the output frequency may be a multiple of the carrier frequency (e.g., twice the carrier frequency, four times the carrier frequency) and used in conjunction with quadrature generator and divider circuitry to generate multiple signals at the carrier frequency with multiple different phases with respect to each other. In some embodiments, the output frequency may be a LO frequency (fLO). In some embodiments, the RF circuitry 1006 may include an IQ/polar converter.

FEM circuitry 1008 may include a receive signal path which may include circuitry configured to operate on RF signals received from one or more antennas 1010, amplify the received signals and provide the amplified versions of the received signals to the RF circuitry 1006 for further processing. FEM circuitry 1008 may also include a transmit signal path which may include circuitry configured to amplify signals for transmission provided by the RF circuitry 1006 for transmission by one or more of the one or more antennas 1010. In various embodiments, the amplification through the transmit or receive signal paths may be done solely in the RF circuitry 1006, solely in the FEM 1008, or in both the RF circuitry 1006 and the FEM 1008.

In some embodiments, the FEM circuitry 1008 may include a TX/RX switch to switch between transmit mode and receive mode operation. The FEM circuitry may include a receive signal path and a transmit signal path. The receive signal path of the FEM circuitry may include an LNA to amplify received RF signals and provide the amplified received RF signals as an output (e.g., to the RF circuitry 1006). The transmit signal path of the FEM circuitry 1008 may include a power amplifier (PA) to amplify input RF signals (e.g., provided by RF circuitry 1006), and one or more filters to generate RF signals for subsequent transmission (e.g., by one or more of the one or more antennas 1010).

In some embodiments, the PMC 1012 may manage power provided to the baseband circuitry 1004. In particular, the PMC 1012 may control power-source selection, voltage scaling, battery charging, or DC-to-DC conversion. The PMC 1012 may often be included when the device 1000 is capable of being powered by a battery, for example, when the device is included in a UE. The PMC 1012 may increase the power conversion efficiency while providing desirable implementation size and heat dissipation characteristics.

While FIG. 10 shows the PMC 1012 coupled only with the baseband circuitry 1004.

However, in other embodiments, the PMC 1012 may be additionally or alternatively coupled with, and perform similar power management operations for, other components such as, but not limited to, application circuitry 1002, RF circuitry 1006, or FEM 1008.

In some embodiments, the PMC 1012 may control, or otherwise be part of, various power saving mechanisms of the device 1000. For example, if the device 1000 is in an RRC_Connected state, where it is still connected to the AN as it expects to receive traffic shortly, then it may enter a state known as Discontinuous Reception Mode (DRX) after a period of inactivity. During this state, the device 1000 may power down for brief intervals of time and thus save power.

If there is no data traffic activity for an extended period of time, then the device 1000 may transition off to an RRC_Idle state, where it disconnects from the network and does not perform operations such as channel quality feedback, handover, etc. The device 1000 goes into a very low power state and it performs paging where again it periodically wakes up to listen to the network and then powers down again. The device 1000 may not receive data in this state, in order to receive data, it must transition back to RRC_Connected state.

An additional power saving mode may allow a device to be unavailable to the network for periods longer than a paging interval (ranging from seconds to a few hours). During this time, the device is totally unreachable to the network and may power down completely. Any data sent during this time incurs a large delay and it is assumed the delay is acceptable.

Processors of the application circuitry 1002 and processors of the baseband circuitry 1004 may be used to execute elements of one or more instances of a protocol stack. For example, processors of the baseband circuitry 1004, alone or in combination, may be used execute Layer 3, Layer 2, or Layer 1 functionality, while processors of the application circuitry 1004 may utilize data (e.g., packet data) received from these layers and further execute Layer 4 functionality (e.g., transmission communication protocol (TCP) and user datagram protocol (UDP) layers). As referred to herein, Layer 3 may comprise a radio resource control (RRC) layer. As referred to herein, Layer 2 may comprise a medium access control (MAC) layer, a radio link control (RLC) layer, and a packet data convergence protocol (PDCP) layer, Layer 1 may comprise a physical (PHY) layer of a UE/AN.

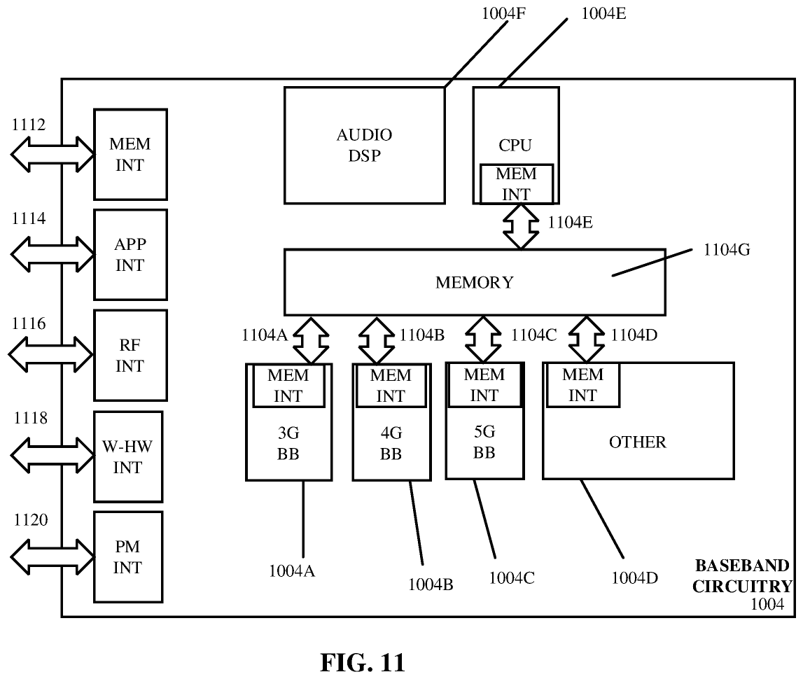

FIG. 11 illustrates example interfaces of baseband circuitry in accordance with some embodiments. As discussed above, the baseband circuitry 1004 of FIG. 10 may comprise processors 1004A-1004E and a memory 1004G utilized by said processors. Each of the processors 1004A-1004E may include a memory interface, 1104A-1104E, respectively, to send/receive data to/from the memory 1004G.

The baseband circuitry 1004 may further include one or more interfaces to communicatively couple to other circuitries/devices, such as a memory interface 1112 (e.g., an interface to send/receive data to/from memory external to the baseband circuitry 1004), an application circuitry interface 1114 (e.g., an interface to send/receive data to/from the application circuitry 1002 of FIG. 10), an RF circuitry interface 1116 (e.g., an interface to send/receive data to/from RF circuitry 1006 of FIG. 10), a wireless hardware connectivity interface 1118 (e.g., an interface to send/receive data to/from Near Field Communication (NFC) components, Bluetooth® components (e.g., Bluetooth® Low Energy), Wi-Fi® components, and other communication components), and a power management interface 1120 (e.g., an interface to send/receive power or control signals to/from the PMC 1112.

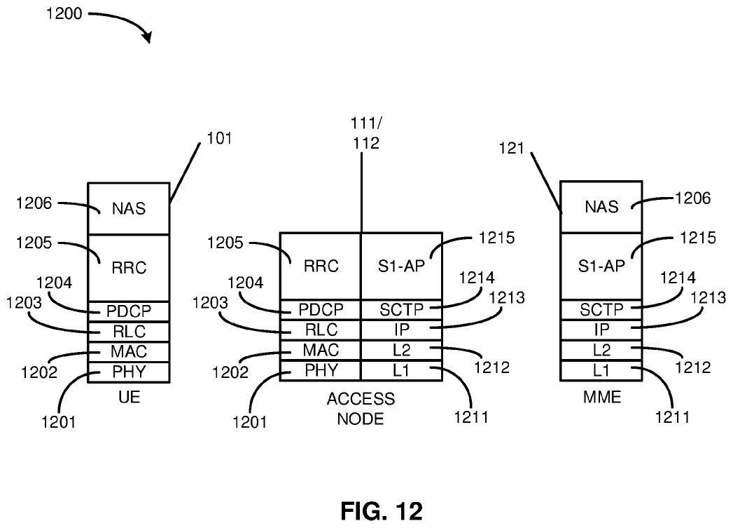

FIG. 12 is an illustration of a control plane protocol stack in accordance with some embodiments. In this embodiment, a control plane 1200 is shown as a communications protocol stack between the UE 101, the AN 111 (or alternatively, the AN 112), and the NDE 121.

The PHY layer 1201 may transmit or receive information used by the MAC layer 1202 over one or more air interfaces. The PHY layer 1201 may further perform link adaptation or adaptive modulation and coding (AMC), power control, cell search (e.g., for initial synchronization and handover purposes), and other measurements used by higher layers, such as the RRC layer 1205. The PHY layer 1201 may still further perform error detection on the transport channels, forward error correction (FEC) coding/decoding of the transport channels, modulation/demodulation of physical channels, interleaving, rate matching, mapping onto physical channels, and Multiple Input Multiple Output (MIMO) antenna processing.

The MAC layer 1202 may perform mapping between logical channels and transport channels, multiplexing of MAC service data units (SDUs) from one or more logical channels onto transport blocks (TB) to be delivered to PHY via transport channels, de-multiplexing MAC SDUs to one or more logical channels from transport blocks (TB) delivered from the PHY via transport channels, multiplexing MAC SDUs onto TBs, scheduling information reporting, error correction through hybrid automatic repeat request (HARQ), and logical channel prioritization.

The RLC layer 1203 may operate in a plurality of modes of operation, including: Transparent Mode (TM), Unacknowledged Mode (UM), and Acknowledged Mode (AM). The RLC layer 1203 may execute transfer of upper layer protocol data units (PDUs), error correction through automatic repeat request (ARQ) for AM data transfers, and concatenation, segmentation and reassembly of RLC SDUs for UM and AM data transfers. The RLC layer 1203 may also execute re-segmentation of RLC data PDUs for AM data transfers, reorder RLC data PDUs for UM and AM data transfers, detect duplicate data for UM and AM data transfers, discard RLC SDUs for UM and AM data transfers, detect protocol errors for AM data transfers, and perform RLC re-establishment.

The PDCP layer 1204 may execute header compression and decompression of IP data, maintain PDCP Sequence Numbers (SNs), perform in-sequence delivery of upper layer PDUs at re-establishment of lower layers, eliminate duplicates of lower layer SDUs at re-establishment of lower layers for radio bearers mapped on RLC AM, cipher and decipher control plane data, perform integrity protection and integrity verification of control plane data, control timer-based discard of data, and perform security operations (e.g., ciphering, deciphering, integrity protection, integrity verification, etc.).

The main services and functions of the RRC layer 1205 may include broadcast of system information (e.g., included in Master Information Blocks (MIBs) or System Information Blocks (SIBs) related to the non-access stratum (NAS)), broadcast of system information related to the access stratum (AS), paging, establishment, maintenance and release of an RRC connection between the UE and E-UTRAN (e.g., RRC connection paging, RRC connection establishment, RRC connection modification, and RRC connection release), establishment, configuration, maintenance and release of point to point Radio Bearers, security functions including key management, inter radio access technology (RAT) mobility, and measurement configuration for UE measurement reporting. Said MIBs and SIBs may comprise one or more information elements (IEs), which may each comprise individual data fields or data structures.

The UE 101 and the AN 111 may utilize a Uu interface (e.g., an LTE-Uu interface) to exchange control plane data via a protocol stack comprising the PHY layer 1201, the MAC layer 1202, the RLC layer 1203, the PDCP layer 1204, and the RRC layer 1205.

The non-access stratum (NAS) protocols 1206 form the highest stratum of the control plane between the UE 101 and the MME 121. The NAS protocols 1206 support the mobility of the UE 101 and the session management procedures to establish and maintain IP connectivity between the UE 101 and the P-GW 123.

The S1 Application Protocol (S1-AP) layer 1215 may support the functions of the S1 interface and comprise Elementary Procedures (EPs). An EP is a unit of interaction between the AN 111 and the CN 120. The S1-AP layer services may comprise two groups: UE-associated services and non UE-associated services. These services perform functions including, but not limited to: E-UTRAN Radio Access Bearer (E-RAB) management, UE capability indication, mobility, NAS signaling transport, RAN Information Management (RIM), and configuration transfer.

The Stream Control Transmission Protocol (SCTP) layer (alternatively referred to as the SCTP/IP layer) 1214 may ensure reliable delivery of signaling messages between the AN 111 and the MME 121 based, in part, on the IP protocol, supported by the IP layer 1213. The L2 layer 1212 and the L1 layer 1211 may refer to communication links (e.g., wired or wireless) used by the RAN node and the MME to exchange information.

The AN 111 and the MME 121 may utilize an S1-MME interface to exchange control plane data via a protocol stack comprising the L1 layer 1211, the L2 layer 1212, the IP layer 1213, the SCTP layer 1214, and the S1-AP layer 1215.

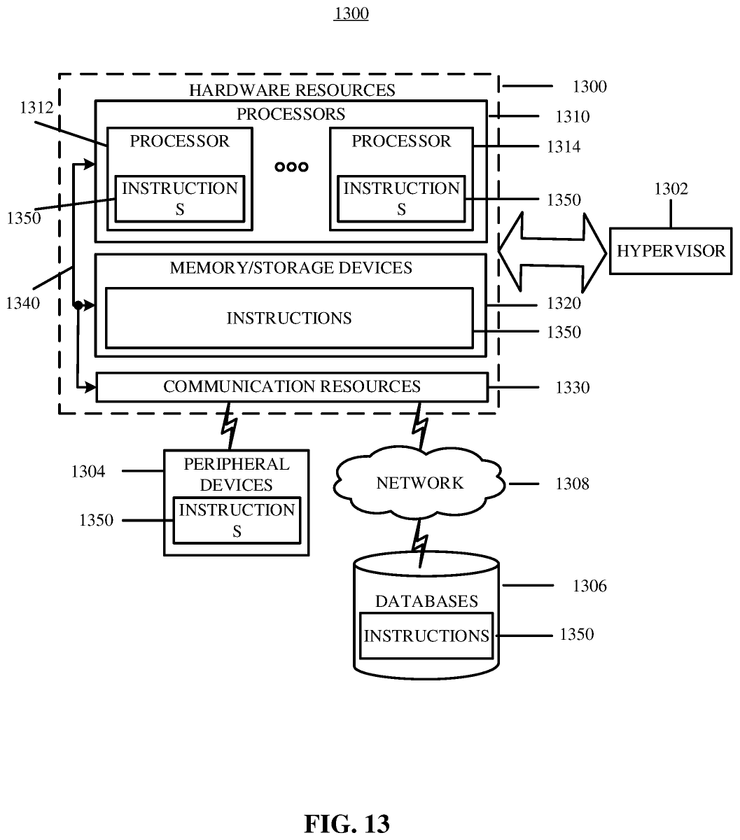

FIG. 13 is a block diagram illustrating components, according to some example embodiments, able to read instructions from a machine-readable or computer-readable medium (e.g., a non-transitory machine-readable storage medium) and perform any one or more of the methodologies discussed herein. Specifically, FIG. 13 shows a diagrammatic representation of hardware resources 1300 including one or more processors (or processor cores) 1310, one or more memory/storage devices 1320, and one or more communication resources 1330, each of which may be communicatively coupled via a bus 1340. For embodiments where node virtualization (e.g., NFV) is utilized, a hypervisor 1302 may be executed to provide an execution environment for one or more network slices/sub-slices to utilize the hardware resources 1300.

The processors 1310 (e.g., a central processing unit (CPU), a reduced instruction set computing (RISC) processor, a complex instruction set computing (CISC) processor, a graphics processing unit (GPU), a digital signal processor (DSP) such as a baseband processor, an application specific integrated circuit (ASIC), a radio-frequency integrated circuit (RFIC), another processor, or any suitable combination thereof) may include, for example, a processor 1312 and a processor 1314.

The memory/storage devices 1320 may include main memory, disk storage, or any suitable combination thereof. The memory/storage devices 1320 may include, but are not limited to any type of volatile or non-volatile memory such as dynamic random access memory (DRAM), static random-access memory (SRAM), erasable programmable read-only memory (EPROM), electrically erasable programmable read-only memory (EEPROM), Flash memory, solid-state storage, etc.

The communication resources 1330 may include interconnection or network interface components or other suitable devices to communicate with one or more peripheral devices 1304 or one or more databases 1306 via a network 1308. For example, the communication resources 1330 may include wired communication components (e.g., for coupling via a Universal Serial Bus (USB)), cellular communication components, NFC components, Bluetooth® components (e.g., Bluetooth® Low Energy), Wi-Fi® components, and other communication components.

Instructions 1350 may comprise software, a program, an application, an applet, an app, or other executable code for causing at least any of the processors 1310 to perform any one or more of the methodologies discussed herein. The instructions 1350 may reside, completely or partially, within at least one of the processors 1310 (e.g., within the processor's cache memory), the memory/storage devices 1320, or any suitable combination thereof. Furthermore, any portion of the instructions 1350 may be transferred to the hardware resources 1300 from any combination of the peripheral devices 1304 or the databases 1306. Accordingly, the memory of processors 1310, the memory/storage devices 1320, the peripheral devices 1304, and the databases 1306 are examples of computer-readable and machine-readable media.

The following paragraphs describe examples of various embodiments.

Example 1 includes an apparatus for a user equipment (UE), including a radio frequency (RF) interface; and processing circuitry configured to: determine beam quality for one or more beam pair links (BPLs) between the UE and an access node; and in response to the beam quality for all of the BPLs being below a first predetermined threshold, encode Physical Random Access Channel (PRACH) data to include a beam recovery request that identifies a candidate beam of the access node; determine a transmit power for the beam recovery request; and send the PRACH data to the RF interface for transmission to the access node with the transmit power.

Example 2 includes the apparatus of Example 1, wherein the processing circuitry is further configured to determine the transmit power based on a maximum transmit power for the UE, and a weight which is configured by a higher layer signaling.

Example 3 includes the apparatus of Example 1, wherein the processing circuitry is further configured to determine the transmit power based on a path loss between the UE and the access node, a predetermined receive power for the access node which is configured by a higher layer signaling, a weight which is configured by a higher layer signaling, and a predetermined power offset.

Example 4 includes the apparatus of Example 1, wherein the processing circuitry is further configured to determine the transmit power based on a transmit power of a previous uplink signal, and a predetermined power offset.

Example 5 includes the apparatus of Example 3 or 4, wherein the predetermined power offset is a difference between a receive power of a current receive beam of the access node and a receive power of a worse receive beam of the access node.

Example 6 includes the apparatus of Example 3 or 4, wherein the predetermined power offset is a difference between a receive power of a current receive beam of the access node and a receive power of the candidate beam of the access node.

Example 7 includes the apparatus of Example 3 or 4, wherein predetermined power offset is a difference between an average receive power of a subset of receive beams of the access node and a receive power of the candidate beam of the access node.

Example 8 includes the apparatus of Example 1, wherein the candidate beam of the access node is identified based on a time resource of the PRACH and/or a frequency resource of the PRACH.

Example 9 includes the apparatus of Example 8, wherein the time resource of the PRACH is a symbol index, a slot index, a sub frame index, or a frame index of the PRACH.

Example 10 includes the apparatus of Example 1, wherein the candidate beam of the access node is a beam for a Synchronization Signal (SS) block or a beam for a Channel State Information Reference Signal (CSI-RS).

Example 11 includes the apparatus of Example 1, wherein the processing circuitry is further configured to choose the candidate beam of the access node from a set of beams of the access node, wherein the set of beams is preconfigured by a higher layer signaling via New radio (NR) minimum system information (MSI), NR remaining minimum system information (RMSI), a NR system information block (SIB), or a radio resource control (RRC) signaling.

Example 12 includes an apparatus for a user equipment (UE), including a radio frequency (RF) interface; and processing circuitry configured to: determine beam quality for one or more beam pair links (BPLs) between the UE and an access node; select, in response to the beam quality for all of the BPLs being below a first predetermined threshold, a channel from a Physical Random Access Channel (PRACH) and a Physical Uplink Control Channel (PUCCH) for transmission of a beam recovery request that identifies a candidate beam of the access node; and encode the beam recovery request for transmission via the selected channel.

Example 13 includes the apparatus of Example 12, wherein the processing circuitry is further configured to: determine a Reference Signal Receiving Power (RSRP) of a reference signal received from the access node; select the PRACH when the RSRP is higher than a second predetermined threshold; and select the PUCCH when the RSRP is lower than the second predetermined threshold.

Example 14 includes the apparatus of Example 12, wherein the processing circuitry is further configured to: determine whether the candidate beam of the access node and a current receive beam of the access node is within a same group which is preconfigured by a higher layer signaling; select the PRACH when it is determined that the candidate beam and the current receive beam is within the same group; and select the PUCCH when it is determined that the candidate beam and the current receive beam is not within the same group.

Example 15 includes the apparatus of Example 12, wherein the beam recovery request is transmitted via the PUCCH, and the processing circuitry is further configured to identify the candidate beam of the access node based on a candidate beam index carried by the PUCCH.

Example 16 includes the apparatus of Example 15, wherein the candidate beam index is a beam index of a beam for a Synchronization Signal (SS) block or a beam index of a beam for a Channel State Information Reference Signal (CSI-RS).

Example 17 includes the apparatus of Example 16, wherein the beam index of the beam for the SS block is a timing index carried by a Demodulation Reference Signal (DMRS) of a Physical Broadcast Channel (PBCH) of the SS block, and the beam index of the beam for the CSI-RS is an antenna port index of the CSI-RS or a CSI-RS resource index (CRI).

Example 18 includes a method performed at a user equipment (UE), including: determining beam quality for one or more beam pair links (BPLs) between the UE and an access node; and in response to the beam quality for all of the BPLs being below a first predetermined threshold, encoding Physical Random Access Channel (PRACH) data to include a beam recovery request that identifies a candidate beam of the access node; determining a transmit power for the beam recovery request; and transmitting the PRACH data to the access node with the transmit power.

Example 19 includes the method of Example 18, wherein the transmit power is determined based on a maximum transmit power for the UE, and a weight which is configured by a higher layer signaling.

Example 20 includes the method of Example 18, wherein the transmit power is determined based on a path loss between the UE and the access node, a predetermined receive power for the access node which is configured by a higher layer signaling, a weight which is configured by a higher layer signaling, and a predetermined power offset.

Example 21 includes the method of Example 18, wherein the transmit power is determined based on a transmit power of a previous uplink signal, and a predetermined power offset.

Example 22 includes the method of Example 20 or 21, wherein the predetermined power offset is a difference between a receive power of a current receive beam of the access node and a receive power of a worse receive beam of the access node.

Example 23 includes the method of Example 20 or 21, wherein the predetermined power offset is a difference between a receive power of a current receive beam of the access node and a receive power of the candidate beam of the access node.

Example 24 includes the method of Example 20 or 21, wherein the predetermined power offset is a difference between an average receive power of a subset of receive beams of the access node and a receive power of the candidate beam of the access node.

Example 25 includes the method of Example 18, wherein the candidate beam of the access node is identified based on a time resource of the PRACH and/or a frequency resource of the PRACH.

Example 26 includes the method of Example 15, wherein the time resource of the PRACH is a symbol index, a slot index, a sub frame index, or a frame index of the PRACH.

Example 27 includes the method of Example 18, wherein the candidate beam of the access node is a beam for a Synchronization Signal (SS) block or a beam for a Channel State Information Reference Signal (CSI-RS).

Example 28 includes the method of Example 187, wherein the candidate beam of the access node is chosen from a set of beams of the access node, wherein the set of beams is preconfigured by a higher layer signaling via New radio (NR) minimum system information (MSI), NR remaining minimum system information (RMSI), a NR system information block (SIB), or a radio resource control (RRC) signaling.

Example 29 includes a method performed at a user equipment (UE), including: determining beam quality for one or more beam pair links (BPLs) between the UE and an access node; selecting, in response to the beam quality for all of the BPLs being below a first predetermined threshold, a channel from a Physical Random Access Channel (PRACH) and a Physical Uplink Control Channel (PUCCH) for transmission of a beam recovery request that identifies a candidate beam of the access node; and encoding the beam recovery request for transmission via the selected channel.

Example 30 includes the method of Example 29, wherein selecting a channel further includes: determining a Reference Signal Receiving Power (RSRP) of a reference signal received from the access node; selecting the PRACH when the RSRP is higher than a second predetermined threshold; and selecting the PUCCH when the RSRP is lower than the second predetermined threshold.

Example 31 includes the method of Example 29, wherein selecting a channel further includes: determining whether the candidate beam of the access node and a current receive beam of the access node is within a same group which is preconfigured by a higher layer signaling; selecting the PRACH when it is determined that the candidate beam and the current receive beam is within the same group; and selecting the PUCCH when it is determined that the candidate beam and the current receive beam is not within the same group.

Example 32 includes the method of Example 29, wherein the beam recovery request is transmitted via the PUCCH, and the candidate beam of the access node is identified based on a candidate beam index carried by the PUCCH.

Example 33 includes the method of Example 32, wherein the candidate beam index is a beam index of a beam for the SS block or a beam index of a beam for the CSI-RS.

Example 34 includes the method of Example 33, wherein the beam index of the beam for the SS block is a timing index carried by a Demodulation Reference Signal (DMRS) of a Physical Broadcast Channel (PBCH) of the SS block, and the beam index of the beam for the CSI-RS is an antenna port index of the CSI-RS or a CSI-RS resource index (CRI).

Example 35 includes a non-transitory computer-readable medium having instructions stored thereon, the instructions when executed by one or more processor(s) causing the processor(s) to perform the method of any of Examples 18-34.

Example 36 includes an apparatus for a user equipment (UE), including means for performing the actions of the method of any of Examples 18-34.

Example 37 includes an apparatus for an access node, including a radio frequency (RF) interface; and processing circuitry configured to: encode a Synchronization Signal (SS) block for transmission to a user equipment (UE); decode a message received from the UE in response to the SS block, wherein the message identifies one or more beam indexes of one or more beams of the access node for the SS block; and update a configuration of a Channel State Information Reference Signal (CSI-RS) based on the decoded message.

Example 38 includes the apparatus of Example 37, wherein each of the beam indexes is a timing index carried by a Demodulation Reference Signal (DMRS) of a Physical Broadcast Channel (PBCH) of the SS block.

Example 39 includes the apparatus of Example 37, wherein the message is received via a Physical Uplink Control Channel (PUCCH), a Medium Access Control (MAC) Control Element (CE), or a Radio Resource Control (RRC) signaling received from the UE.

Example 40 includes the apparatus of Example 37, wherein the message comprises a beam recovery request.

Example 41 includes the apparatus of Example 40, wherein the message is received via a Physical Random Access Channel (PRACH) or a Physical Uplink Control Channel (PUCCH) from the UE.

Example 42 includes the apparatus of Example 37, wherein in the updated configuration, one or more beams of the access node for the CSI-RS are around the one or more beams of the access node for the SS block.

Example 43 includes the apparatus of Example 37, wherein the processing circuitry is further configured to encode the updated configuration of the CSI-RS for transmission to the UE.

Example 44 includes the apparatus of Example 37, wherein the configuration of the CSI-RS comprises at least one of the number of resources for the CSI-RS, a setting of resources for the CSI-RS, an index of each of resources for the CSI-RS, and a periodicity of the CSI-RS.

Example 45 includes an apparatus for a user equipment (UE), including a radio frequency (RF) interface; and processing circuitry configured to: decode a Synchronization Signal (SS) block received from an access node; and encode a message based on the decoded SS block for transmission to the access node, wherein the message identifies one or more beam indexes of one or more beams of the access node for the SS block.

Example 46 includes the apparatus of Example 45, wherein each of the beam indexes is a timing index carried by a Demodulation Reference Signal (DMRS) of a Physical Broadcast Channel (PBCH) of the SS block.

Example 47 includes the apparatus of Example 45, wherein the processing circuitry is further configured to determine beam quality of the one or more beams based on the decoded SS block, and the message further identifies the beam quality of the one or more beams.

Example 48 includes the apparatus of Example 46, wherein the beam quality of each of the one or more beams is determined by measuring a Reference Signal Receiving Power (RSRP) or Reference Signal Receiving Quality (RSRQ) of the decoded RS for the beam.

Example 49 includes the apparatus of Example 45, wherein the message comprises a beam recovery request.

Example 50 includes the apparatus of Example 49, wherein the beam recovery request is encoded for transmission via a Physical Random Access Channel (PRACH) or a Physical Uplink Control Channel (PUCCH).

Example 51 includes the apparatus of Example 45, wherein the message is encoded for transmission via a Physical Uplink Control Channel (PUCCH), a Medium Access Control (MAC) Control Element (CE), or a Radio Resource Control (RRC) signaling.

Example 52 includes the apparatus of Example 45, wherein the processing circuitry is further configured to decode a configuration of a Channel State Information Reference Signal (CSI-RS) received from the access node.

Example 53 includes the apparatus of Example 52, wherein in the decoded configuration, one or more beams of the access node for the CSI-RS are around the one or more beams of the access node for the SS block.

Example 54 includes the apparatus of Example 52, wherein the configuration of the CSI-RS comprises at least one of the number of resources for the CSI-RS, a setting of resources for the CSI-RS, an index of each of resources for the CSI-RS, and a periodicity of the CSI-RS.

Example 55 includes a method performed by an access node, including: encoding a Synchronization Signal (SS) block for transmission to a user equipment (UE); decoding a message received from the UE in response to the SS block, wherein the message identifies one or more beam indexes of one or more beams of the access node for the SS block; and updating a configuration of a Channel State Information Reference Signal (CSI-RS) based on the decoded message.

Example 56 includes the method of Example 55, wherein each of the beam indexes is a timing index carried by a Demodulation Reference Signal (DMRS) of a Physical Broadcast Channel (PBCH) of the SS block.

Example 57 includes the method of Example 55, wherein the message is received via a Physical Uplink Control Channel (PUCCH), a Medium Access Control (MAC) Control Element (CE), or a Radio Resource Control (RRC) signaling received from the UE.

Example 58 includes the method of Example 55, wherein the message comprises a beam recovery request.

Example 59 includes the method of Example 58, wherein the message is received via a Physical Random Access Channel (PRACH) or a Physical Uplink Control Channel (PUCCH) received from the UE.

Example 60 includes the method of Example 55, wherein in the updated configuration, one or more beams of the access node for the CSI-RS are around the one or more beams of the access node for the SS block.

Example 61 includes the method of Example 55, wherein the method further includes encoding the updated configuration of the CSI-RS for transmission to the UE.

Example 62 includes the method of Example 55, wherein the configuration of the CSI-RS comprises at least one of the number of resources for the CSI-RS, a setting of resources for the CSI-RS, an index of each of resources for the CSI-RS, and a periodicity of the CSI-RS.

Example 63 includes a method performed by a user equipment (UE), including: decoding a Synchronization Signal (SS) block received from an access node; and encoding a message based on the decoded SS block for transmission to the access node, wherein the message identifies one or more beam indexes of one or more beams of the access node for the SS block.

Example 64 includes the method of Example 63, wherein each of the beam indexes is a timing index carried by a Demodulation Reference Signal (DMRS) of a Physical Broadcast Channel (PBCH) of the SS block.

Example 65 includes the method of Example 63, wherein the method further includes determining beam quality of the one or more beams based on the decoded SS block, and wherein the message further identifies the beam quality of the one or more beams.

Example 66 includes the method of Example 65, wherein the beam quality of each of the one or more beams is determined by measuring a Reference Signal Receiving Power (RSRP) or Reference Signal Receiving Quality (RSRQ) of the decoded RS for the beam.

Example 67 includes the method of Example 63, wherein the message comprises a beam recovery request.

Example 68 includes the method of Example 67, wherein the beam recovery request is encoded for transmission via a Physical Random Access Channel (PRACH) or a Physical Uplink Control Channel (PUCCH).

Example 69 includes the method of Example 63, wherein the message is encoded for transmission via a Physical Uplink Control Channel (PUCCH), a Medium Access Control (MAC) Control Element (CE), or a Radio Resource Control (RRC) signaling.

Example 70 includes the method of Example 63, wherein the method further includes decoding a configuration of a Channel State Information Reference Signal (CSI-RS) received from the access node.

Example 71 includes the method of Example 70, wherein in the decoded configuration, one or more beams of the access node for the CSI-RS are around the one or more beams of the access node for the SS block.

Example 72 includes the method of Example 70, wherein the configuration of the CSI-RS comprises at least one of the number of resources for the CSI-RS, a setting of resources for the CSI-RS, an index of each of resources for the CSI-RS, and a periodicity of the CSI-RS.

Example 73 includes a non-transitory computer-readable medium having instructions stored thereon, the instructions when executed by one or more processor(s) causing the processor(s) to perform the method of any of Examples 55-72.

Example 74 includes an apparatus for a user equipment (UE), including means for performing the actions of the method of any of Examples 63-72.

Example 75 includes an apparatus for an access node (AN), including means for performing the actions of the method of any of Examples 55-62.

Example 76 includes a user equipment (UE) as shown and described in the description.

Example 77 includes an access node (AN) as shown and described in the description.

Example 78 includes a method performed at a user equipment (UE) as shown and described in the description.

Example 79 includes a method performed at an access node (AN) as shown and described in the description.

Although certain embodiments have been illustrated and described herein for purposes of description, a wide variety of alternate and/or equivalent embodiments or implementations calculated to achieve the same purposes may be substituted for the embodiments shown and described without departing from the scope of the present disclosure. This application is intended to cover any adaptations or variations of the embodiments discussed herein. Therefore, it is manifestly intended that embodiments described herein be limited only by the appended claims and the equivalents thereof.

1. An apparatus for a user equipment (UE), comprising:
a radio frequency (RF) interface; and
one or more processors configured to:
determine beam quality for one or more beam pair links (BPLs) between the UE and an access node; and
in response to the beam quality for all of the BPLs being less than a first predetermined threshold:
encode Physical Random Access Channel (PRACH) data to include a beam recovery request that identifies a candidate beam of the access node;
determine a transmit power for the beam recovery request; and
send the PRACH data to the RF interface for transmission to the access node with the transmit power.

2. The apparatus of claim 1, wherein the one or more processors are further configured to determine the transmit power based on a maximum transmit power for the UE, and a weight which is configured by a higher layer signaling.

3. The apparatus of claim 1, wherein the one or more processors are further configured to determine: the transmit power based on a path loss between the UE and the access node, a predetermined receive power for the access node that is configured by a higher layer signaling, a weight that is configured by a higher layer signaling, and a predetermined power offset.

4. The apparatus of claim 1, wherein the one or more processors are further configured to determine the transmit power based on a transmit power of a previous uplink signal, and a predetermined power offset.

5. The apparatus of claim 3, wherein the predetermined power offset is a difference between a receive power of a current receive beam of the access node and a receive power of a worse receive beam of the access node.

6. The apparatus of claim 3, wherein the predetermined power offset is a difference between a receive power of a current receive beam of the access node and a receive power of the candidate beam of the access node.

7. The apparatus of claim 3, wherein the predetermined power offset is a difference between an average receive power of a subset of receive beams of the access node and a receive power of the candidate beam of the access node.

8. The apparatus of claim 1, wherein the candidate beam of the access node is identified based on a time resource of the PRACH and/or a frequency resource of the PRACH.

9. The apparatus of claim 8, wherein the time resource of the PRACH is a symbol index, a slot index, a sub frame index, or a frame index of the PRACH.

10. The apparatus of claim 1, wherein the candidate beam of the access node is a beam for a Synchronization Signal (SS) block or a beam for a Channel State Information Reference Signal (CSI-RS).

11. The apparatus of claim 1, wherein the one or more processors are further configured to choose the candidate beam of the access node from a set of beams of the access node, wherein the set of beams is preconfigured by a higher layer signaling via New radio (NR) minimum system information (MSI), NR remaining minimum system information (RMSI), a NR system information block (SIB), or a radio resource control (RRC) signaling.

12. An apparatus for a user equipment (UE), comprising:
a radio frequency (RF) interface; and
one or more processors configured to:
determine beam quality for one or more beam pair links (BPLs) between the UE and an access node;
select, in response to the beam quality for all of the BPLs being less than a first predetermined threshold, a channel from a Physical Random Access Channel (PRACH) and a Physical Uplink Control Channel (PUCCH) for transmission of a beam recovery request that identifies a candidate beam of the access node; and
encode the beam recovery request for transmission via the selected channel.

13. The apparatus of claim 12, wherein the one or more processors are further configured to:
determine a Reference Signal Receiving Power (RSRP) of a reference signal received from the access node;
select the PRACH when the RSRP is higher than a second predetermined threshold; and
select the PUCCH when the RSRP is lower than the second predetermined threshold.

14. The apparatus of claim 12, wherein the one or more processors are further configured to:
determine whether the candidate beam of the access node and a current receive beam of the access node is within a same group which is preconfigured by a higher layer signaling;
select the PRACH when it is determined that the candidate beam and the current receive beam is within the same group; and
select the PUCCH when it is determined that the candidate beam and the current receive beam is not within the same group.

15. The apparatus of claim 12, wherein the beam recovery request is transmitted via the PUCCH, and the one or more processors are further configured to identify the candidate beam of the access node based on a candidate beam index carried by the PUCCH.

16. The apparatus of claim 15, wherein the candidate beam index is a beam index of a beam for a Synchronization Signal (SS) block or a beam index of a beam for a Channel State Information Reference Signal (CSI-RS).

17. The apparatus of claim 16, wherein the beam index of the beam for the SS block is a timing index carried by a Demodulation Reference Signal (DMRS) of a Physical Broadcast Channel (PBCH) of the SS block, and the beam index of the beam for the CSI-RS is an antenna port index of the CSI-RS or a CSI-RS resource index (CRI).

18. An apparatus for an access node, comprising:
a radio frequency (RF) interface; and
one or more processors configured to:
encode a Synchronization Signal (SS) block for transmission to a user equipment (UE);
decode a message received from the UE in response to the SS block, wherein the message identifies one or more beam indexes of one or more beams of the access node for the SS block; and
update a configuration of a Channel State Information Reference Signal (CSI-RS) based on the decoded message.

19. The apparatus of claim 18, wherein each of the beam indexes is a timing index carried by a Demodulation Reference Signal (DMRS) of a Physical Broadcast Channel (PBCH) of the SS block.

20. The apparatus of claim 18, wherein the message is received via a Physical Uplink Control Channel (PUCCH), a Medium Access Control (MAC) Control Element (CE), or a Radio Resource Control (RRC) signaling received from the UE.

21-25. (canceled)
